(19) United States
(12) Patent Application Publication
(10) Pub. No.: US 2026/0336175 A1
(43) Pub. Date: Oct. 29, 2026

(54) MOLDING MANAGEMENT SYSTEM

(71) Applicant: SEIKO EPSON CORPORATION, Tokyo (JP)

(72) Inventors: Kosuke ATSUTA, SHIOJIRI-SHI (JP); Satoshi YAMAZAKI, MATSUMOTO-SHI (JP); Atsushi HAIZUKA, SHIOJIRI-SHI (JP)

(21) Appl. No.: 19/658,840

(22) Filed: Apr. 27, 2026

(30) Foreign Application Priority Data
Apr. 28, 2025 (JP) 2025-074227

(51) Int. Cl. B29C 45/76

(52) U.S. Cl. CPC B29C 45/76; B29C 2945/76936; B29C 2945/76943; B29C 2945/76949

(57) ABSTRACT

A molding management system includes an information processing device, and the information processing device determines whether a measurement value of a first management item deviates from at least a first allowable range of the first allowable range and a second allowable range based on output data acquired from an injection molding apparatus, when the measurement value of the first management item deviates from the first allowable range and falls between the first allowable range and the second allowable range, changes an injection molding condition set in the injection molding apparatus under a restriction of changing the measurement value of the first management item within a maximum allowable change amount, and, when the measurement value of the first management item deviates from both the first allowable range and the second allowable range, removes the restriction and changes the injection molding condition set in the injection molding apparatus with the restriction removed.

The present application is based on, and claims priority from JP Application Serial Number 2025-074227, filed Apr. 28, 2025, the disclosure of which is hereby incorporated by reference herein in its entirety.

### BACKGROUND

### 1. Technical Field

The present disclosure relates to a molding management system.

### 2. Related Art

Technologies for managing production of products in a production process including an injection molding step of the products by an injection molding apparatus are being developed.

In this regard, as a method of adjusting an injection molding condition of an injection molding apparatus, there is known an injection molding condition adjustment method including acquiring mold information indicating a feature of a mold, material information indicating properties of a resin material, or defect information indicating a defect phenomenon of a molded article, determining an item of an injection molding condition to be adjusted, an allowable range of a deviation of a measurement value with respect to a target value of a management item managed by a user for securing quality of a product, and a maximum allowable change amount allowable as an amount of change of the measurement value based on the acquired mold information, material information, or defect information, and executing control of injection molding by an injection molding apparatus while changing the injection molding condition based on the determined item of the injection molding condition to be adjusted, allowable range, and maximum allowable change amount (see JP-A-2023-120015). In JP-A-2023-120015, the allowable range is referred to as an adjustment range, and the maximum allowable change amount is referred to as an adjustment increment.

JP-A-2023-120015 is an example of the related art.

Here, in the injection molding condition adjustment method as described in JP-A-2023-120015, the measurement value of the management item may significantly deviate from the target value to the defective side due to 4M (Man, Machine, Method, Material) fluctuations or the like during mass production. In such a case, the injection molding condition adjustment method gradually changes the measurement value significantly deviating from the target value to the defective side by a small maximum allowable change amount. As a result, in the injection molding condition adjustment method, it may take an unnecessarily long time to bring the measurement value close to the target value. This may lower the yield of products injection-molded by the injection molding apparatus, which is not desirable.

### SUMMARY

A molding management system according to an aspect of the present disclosure is a molding management system including an information processing device communicably coupled to a terminal device for management of production of a product in a production process including an injection molding step of the product by an injection molding apparatus, wherein the information processing device acquires output data output from the injection molding apparatus for each cycle of injection molding performed by the injection molding apparatus, the output data is data in which cycle data including measurement value information indicating each of one or more measurement values measured in the injection molding apparatus in response to execution of the cycle by the injection molding apparatus is associated with injection molding condition data including injection molding condition information indicating an injection molding condition set in the injection molding apparatus, the one or more measurement values include a measurement value for each of one or more management items correlated with quality of the product, and the information processing device receives a target value of a first management item among the one or more management items, a first allowable range allowed as a deviation of the measurement value of the first management item from the target value, and a second allowable range allowed as a deviation of the measurement value of the first management item from the first allowable range according to a received operation, determines whether the measurement value of the first management item deviates from at least the first allowable range of the first allowable range and the second allowable range based on the output data acquired from the injection molding apparatus, when the measurement value of the first management item deviates from the first allowable range and falls between the first allowable range and the second allowable range, changes an injection molding condition set in the injection molding apparatus under a restriction of changing the measurement value of the first management item within a maximum allowable change amount that is allowable as an amount of change of the measurement value of the first management item, and, when the measurement value of the first management item deviates from both the first allowable range and the second allowable range, removes the restriction and changes the injection molding condition set in the injection molding apparatus with the restriction removed.

### BRIEF DESCRIPTION OF THE DRAWINGS

FIG. 1 shows an example of a configuration of a molding management system 1.

FIG. 2 is an image diagram of a flow in which quality of a product injection-molded by an injection molding apparatus changes when an injection molding condition is changed.

FIG. 3 is an image diagram of a flow in which an injection molding condition is required to be changed when the quality of the product deteriorates.

FIG. 4 shows an example of a change in a measurement value of a certain management item X for each cycle when the injection molding apparatus continuously executes a plurality of cycles.

FIG. 5 shows another example of a change in the measurement value of the management item X for each cycle when the injection molding apparatus continuously executes a plurality of cycles.

FIG. 6 shows still another example of a change in the measurement value of the management item X for each cycle when the injection molding apparatus continuously executes a plurality of cycles.

FIG. 7 shows an example of a process in which, when the measurement value of a first management item is significantly deviated from a target value, the measurement value is returned to within a first allowable range by first processing by an information processing device 20.

FIG. 8 shows an example of a process in which, when the measurement value of the first management item deviates from the first allowable range, the measurement value is changed to a value within a target neighborhood range by second processing by the information processing device 20.

FIG. 9 shows an example of a hardware configuration of the information processing device 20.

FIG. 10 shows an example of a functional configuration of the information processing device 20.

FIG. 11 shows an example of a flow of processing of setting an injection molding condition in the injection molding apparatus by the information processing device 20.

FIG. 12 shows an example of a flow of processing of receiving various settings by the information processing device 20.

FIG. 13 shows an example of a flow of processing of causing the injection molding apparatus to perform injection molding by the information processing device 20.

FIG. 14 shows another example of the flow of processing of causing the injection molding apparatus to perform injection molding by the information processing device 20.

FIG. 15 shows still another example of the flow of processing of causing the injection molding apparatus to perform injection molding by the information processing device 20.

### DESCRIPTION OF EMBODIMENTS

### Embodiments

Embodiments of the present disclosure will be described below with reference to the drawings.

### Overview of Molding Management System

First, an overview of a molding management system according to the embodiment will be described.

A molding management system according to an embodiment manages production of a product in a production process including an injection molding step of the product by an injection molding apparatus. The molding management system includes an information processing device. The information processing device is communicably coupled to a terminal device. The information processing device acquires output data output from the injection molding apparatus for each cycle of injection molding performed by the injection molding apparatus. Here, the output data is data in which cycle data including measurement value information indicating each of one or more measurement values measured in the injection molding apparatus in response to execution of the cycle by the injection molding apparatus is associated with injection molding condition data including injection molding condition information indicating an injection molding condition set in the injection molding apparatus. The one or more measurement values include a measurement value for each of one or more management items correlated with the quality of the product. According to the received operation, the information processing device receives a target value of a first management item among the one or more management items, a first allowable range allowed as a deviation of a measurement value of the first management item from the target value, and a second allowable range allowed as a deviation of the measurement value of the first management item from the first allowable range. Furthermore, the information processing device determines whether the measurement value of the first management item deviates from at least the first allowable range of the first allowable range and the second allowable range based on the output data acquired from the injection molding apparatus, changes the injection molding condition set in the injection molding apparatus under the restriction of changing the measurement value of the first management item within the maximum allowable change amount allowable as the amount of change in the measurement value of the first management item when the measurement value of the first management item deviates from the first allowable range and falls between the first allowable range and the second allowable range, removes the restriction when the measurement value of the first management item deviates from both the first allowable range and the second allowable range, and changes the injection molding condition set in the injection molding apparatus with the restriction removed. As a result, the information processing device can quickly bring the measurement value of the management item close to the target value when the measurement value deviates significantly from the target value, and can prevent the measurement value from deviating significantly from the target value when the measurement value deviates slightly from the target value. As a result, the information processing device can prevent an increase in the time required to bring the measurement value of the management item close to the target value.

A molding management system according to an embodiment manages production of a product in a production process including an injection molding step of the product by an injection molding apparatus. The molding management system includes an information processing device. The information processing device is communicably coupled to a terminal device. The information processing device acquires output data output from the injection molding apparatus for each cycle of injection molding performed by the injection molding apparatus. Here, the output data is data in which cycle data including measurement value information indicating each of one or more measurement values measured in the injection molding apparatus in response to execution of the cycle by the injection molding apparatus is associated with injection molding condition data including injection molding condition information indicating an injection molding condition set in the injection molding apparatus. The one or more measurement values include a measurement value for each of one or more management items correlated with the quality of the product. According to the received operation, the information processing device receives a target value of a first management item among the one or more management items, a first allowable range allowed as a deviation of a measurement value of the first management item from the target value, and a target neighborhood range indicating a neighborhood of the target value of the measurement value of the first management item. Accordingly, the information processing device can prevent the vibration of the measurement value of the management item near the upper limit value or the lower limit value of the first allowable range, and can more reliably bring the measurement value closer to the target value. As a result, the information processing device can improve the stability of injection molding by the injection molding apparatus while preventing deterioration in the quality of the product.

In the following description, a configuration of the molding management system according to the embodiments and processing performed by a server provided in the molding management system will be described in detail.

### Configuration of Molding Management System

Hereinafter, the configuration of the molding management system according to the embodiments will be described by taking the molding management system 1 as an example.

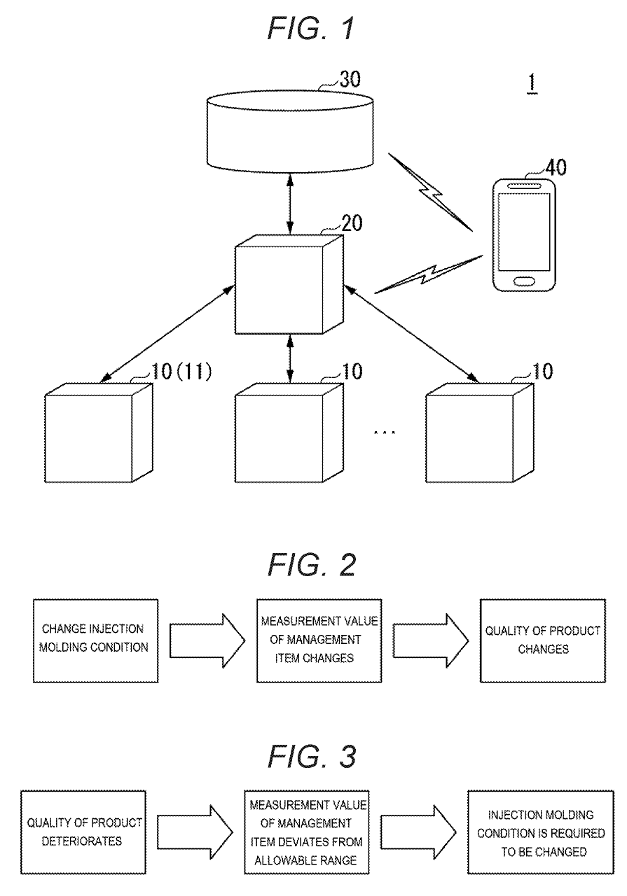

FIG. 1 shows an example of a configuration of the molding management system 1.

The molding management system 1 is a type of manufacturing execution system (MES). For example, the molding management system 1 includes one or more managed devices 10, an information processing device 20, and a server 30. The molding management system 1 may be configured not to include some or all of the one or more managed devices 10. The molding management system 1 may include the server 30 without including the information processing device 20. The molding management system 1 may include the information processing device 20 without including the server 30. In the molding management system 1, the information processing device 20 may be configured integrally with the server 30. Hereinafter, as an example, a case where the molding management system 1 includes a plurality of managed devices 10 as the one or more managed devices 10 will be described. Furthermore, hereinafter, as an example, a case where the molding management system 1 includes both the information processing device 20 and the server 30 separate from the information processing device 20 will be described. At least one of the information processing device 20 and the server 30 is an example of the information processing device.

Each of the plurality of managed devices 10 provided in the molding management system 1 is a device managed by the molding management system 1. In FIG. 1, for convenience of description, the plurality of managed devices 10 are indicated by the same sign. However, some or all of the plurality of managed devices 10 may be devices of types different from one another. The plurality of managed devices 10 include at least one injection molding apparatus that performs injection molding of a product using resin such as plastic. An injection molding apparatus 11 shown in FIG. 1 is an example of the injection molding apparatus. The plurality of managed devices 10 may include an injection molding apparatus that performs metal injection molding (MIM) of a product. Hereinafter, for convenience of description, injection molding of a product using resin such as plastic is simply referred to as injection molding. Furthermore, hereinafter, the injection molding apparatus that performs the injection molding of a product using resin such as plastic is simply referred to as an injection molding apparatus. At least one injection molding apparatus in the plurality of managed devices 10 may be a device that performs injection molding using a material other than resin and metal. In addition to the injection molding apparatus, the plurality of managed devices 10 include, for example, peripheral equipment of the injection molding apparatus. Examples of the peripheral equipment of the injection molding apparatus include, but are not limited to, a material supply device, a conveying device, a cleaning device, and a sintering device. Here, the material supply device is a device that supplies a material used for injection molding of a product by the injection molding apparatus to the injection molding apparatus. The conveying device is a device that conveys a product injection-molded by the injection molding apparatus. The cleaning device is a device that cleans a product injection-molded by the injection molding apparatus. The sintering device is a device that sinters a product after being cleaned by the cleaning device.

The molding management system 1 manages production of a product in a production process including an injection molding step of the product performed by the injection molding apparatus in the plurality of managed devices 10. Here, the injection molding apparatus in the plurality of managed devices 10 may have any configuration as long as the configuration is capable of producing a product by injection molding. Hereinafter, for convenience of description, a step in which the injection molding apparatus performs injection molding of a product once is referred to as a cycle. Furthermore, hereinafter, for convenience of description, a hollow in a mold attached to the injection molding apparatus is referred to as a cavity. That is, the injection molding apparatus performs injection molding of a product by injecting a material into the cavity in the mold attached to the injection molding apparatus and applying a pressure to the material in the cavity.

Here, one or more injection molding apparatuses in the plurality of managed devices 10 each include an extrusion unit that extrudes, in the injection molding step, a material used for injection molding of the product into the cavity in the mold attached to the injection molding apparatus. The extrusion unit is, for example, a screw that moves a position in a cylinder back and forth by rotating in the cylinder. Instead of the screw, the extrusion unit may be a member that moves the position in the cylinder back and forth by a hydraulic pressure, a linear actuator, or the like. The material is extruded from an injection port of the cylinder toward the cavity in the mold in response to advance of the extrusion unit in the cylinder. Hereinafter, for convenience of description, the extrusion unit provided in the injection molding apparatus is referred to as the screw.

One or more measurement units are attached to the one or more injection molding apparatuses in the plurality of managed devices 10. The one or more measurement units measure various measurable parameters that can be measured in the injection molding apparatus in each cycle. The measurable parameters include, but are not limited to, for example, some or all of a position of the screw, an injection speed as a speed at which the material is injected into the cavity in the mold by the screw, a rotation speed of the screw, an injection holding pressure as a pressure in the mold held by the screw, and a temperature in the mold. The measurable parameters include a parameter by which a target value can be set in the injection molding apparatus. In other words, the measurable parameters include parameters that can be controlled by the injection molding apparatus. Therefore, hereinafter, for convenience of description, a parameter by which a target value can be set in the injection molding apparatus among the measurable parameters will be referred to as a settable parameter. Here, when a target value is set in the injection molding apparatus for a certain settable parameter, the injection molding apparatus controls the settable parameter such that a measurement value of the settable parameter is closer to the target value during execution of the cycle. Therefore, hereinafter, for convenience of description, among the settable parameters, a settable parameter for which one or more target values are set in the injection molding apparatus will be described as a control parameter. Furthermore, hereinafter, for convenience of description, one or more target values for each control parameter will be collectively referred to as an injection molding condition. This is because the injection molding apparatus performs injection molding by controlling the control parameter, and when the target value of the control parameter is changed, the quality of the product injection-molded by the injection molding apparatus changes. Note that a measurement value measured by a certain measurement unit may be referred to as an actual value.

Here, a measurement unit that measures a certain measurement value among one or more measurement units attached to a certain injection molding apparatus includes, but is not limited to, for example, a sensor that measures the measurement value. The one or more measurement units may include a measurement unit that measures the quality of a product. This is because the quality of the product is also controlled by the injection molding apparatus in each cycle. In this case, the measurement unit includes, but is not limited to, for example, a device that includes an imaging unit capable of imaging the product to measure the quality of the product. In this case, for example, a quantity indicating the quality of the product measured by the measurement unit includes, but is not limited to, for example, one of a plurality of predetermined values arranged in descending order of quality.

The information processing device 20 selects each of one or more settable parameters desired by the user from among one or more settable parameters as a management item according to the received operation. The management item is a settable parameter selected by the user as a settable parameter correlated with the quality of the product to be injection-molded by the injection molding apparatus. In other words, the management item is a settable parameter that the user wishes to manage to maintain the quality of the product. Therefore, the measurable parameters having the measurement value that can be measured in the injection molding apparatus include the settable parameter by which the target value can be set. The settable parameters include a control parameter in which a target value is actually set as an injection molding condition and a management item managed by the user. In a Venn diagram, a part of the set of control parameters may overlap a part of the set of management items. That is, some of the control parameters can also be selected as management items. The management item may be referred to as a management parameter. In addition, a target value as a target to which the measurement value is indirectly brought close by the control of the control parameter is assigned to the management item that is not the control parameter. However, the target value is not a target value in the control of the management item, that is, a value set in the injection molding apparatus as an injection molding condition. The target value of the management item that is not the control parameter is a value simply used in the management of the management item.

The information processing device 20 acquires the cycle data for each cycle from each of the one or more injection molding apparatuses in the plurality of managed devices 10. More specifically, the information processing device 20 acquires the cycle data from each of the one or more injection molding apparatuses at each time when each cycle ends. Hereinafter, for convenience of description, the cycle data acquired when a certain cycle ends is referred to as cycle data of the cycle. Further, hereinafter, for convenience of description, a cycle that ends when certain cycle data is acquired is referred to as a cycle of the cycle data.

The cycle data of a certain cycle is information including one or more pieces of cycle-related information obtained as a result of execution of the cycle by the injection molding apparatus that is an acquisition source of the cycle data, apparatus identification information for identifying the injection molding apparatus, and first date-and-time information indicating date and time when the cycle data is acquired from the injection molding apparatus by the information processing device 20. The apparatus identification information is, for example, an identifier (ID) for identifying the injection molding apparatus, and may be other information through which the injection molding apparatus can be identified, such as an Internet protocol (IP) address assigned to the injection molding apparatus. The first date-and-time information may be a time stamp or other information indicating the date and time. The cycle data may include other information in addition to the one or more pieces of cycle-related information, the apparatus identification information, and the first date-and-time information. The apparatus identification information may be contained in the cycle data as one of the one or more pieces of cycle-related information. Hereinafter, as an example, a case where the apparatus identification information is contained in the cycle data as one of the one or more pieces of cycle-related information will be described.

The one or more pieces of cycle-related information contained in cycle data of a certain cycle include one or more pieces of measurement value information in addition to apparatus identification information for identifying the injection molding apparatus as an acquisition source of the cycle data. Each of the one or more pieces of measurement value information is information indicating a measurement value measured by each of the one or more measurement units in the injection molding apparatus. That is, the one or more pieces of cycle-related information include measurement value information such as measurement value information indicating the measurement value of the control parameter and measurement value information indicating the measurement value of the management item. The one or more pieces of measurement value information contained in the one or more pieces of cycle-related information include measurement value information indicating a measurement value continuously measured during execution of the cycle by the injection molding apparatus in addition to measurement value information indicating a measurement value obtained as a result of measurement performed only once during execution of the cycle by the injection molding apparatus. Hereinafter, for convenience of description, the measurement value will be referred to as a time-series measurement value. The measurement value information indicating the time-series measurement value includes time-series information indicating a time series of the time-series measurement value and feature value information indicating one or more types of feature values for the time-series measurement value. Here, the one or more types of feature values for a certain time-series measurement value are, for example, at least one of a minimum value, a maximum value, an average value, a variance, and a standard deviation of the time-series measurement value, a start value of a period in which the time-series measurement value is measured, and an end value of the period. That is, the one or more types of feature values are values indicating features of a waveform indicating a temporal change in the time-series measurement value. The one or more types of feature values may include another value obtained by statistical processing on the time-series measurement value, instead of some or all of the feature values or in addition to all of the feature values. The feature value information may be contained in the measurement value information in the injection molding apparatus or the information processing device 20. This is because the information processing device 20 can calculate the one or more types of feature values based on the time-series information. The measurement value information may not include the time-series information as long as including the feature value information. Hereinafter, as an example, a case where the measurement value information includes both the time-series information and the feature value information will be described. The feature value information may be the time-series information. This is also because the information processing device 20 can calculate the one or more types of feature values based on the time-series information.

The one or more pieces of cycle-related information contained in the cycle data of a certain cycle may include other information in addition to the apparatus identification information for identifying the injection molding apparatus as the acquisition source of the cycle data and the one or more pieces of measurement value information. The other information includes, but is not limited to, for example, some or all of cycle identification information for identifying the cycle, operation state information, and product quantity information. Here, the operation state information contained in the cycle data as the cycle-related information is information indicating an operation state of the injection molding apparatus. The product quantity information contained in the cycle data as the cycle-related information is information indicating the number of products injection-molded by the injection molding apparatus in the cycle. The cycle identification information is, for example, information indicating the order in which the cycle is executed in a plurality of cycles that are continuously executed. This is because the cycle can be uniquely specified by combining the information with the first date-and-time information. The cycle identification information may be information by which the cycle can be uniquely identified by the cycle identification information alone, or may be other information by which the cycle can be identified.

The cycle data as described above can be discriminated by the cycle identification information described above, but can also be discriminated by a combination of the apparatus identification information and the first date-and-time information. Therefore, the cycle data may not include the cycle identification information. When there is only one injection molding apparatus coupled to the information processing device 20, the cycle data may not include the apparatus identification information. This is because, in this case, each piece of cycle data can be discriminated simply by the first date-and-time information.

When acquiring certain cycle data, the information processing device 20 stores the acquired cycle data and outputs the acquired cycle data to the server 30. Accordingly, the information processing device 20 can also store the acquired cycle data in the server 30.

Furthermore, the information processing device 20 acquires the injection molding condition data from each of the one or more injection molding apparatuses in the plurality of managed devices 10 at each time when an injection molding condition is set in the injection molding apparatus.

Here, the injection molding condition data acquired from a certain injection molding apparatus is information including one or more pieces of injection molding condition information each indicating the injection molding condition set in the injection molding apparatus, the apparatus identification information for identifying the injection molding apparatus, and second date-and-time information indicating date and time when the injection molding condition data is acquired by the information processing device 20 from the injection molding apparatus. The apparatus identification information is, for example, an ID for identifying the injection molding apparatus, and may be other information through which the injection molding apparatus can be identified, such as an IP address assigned to the injection molding apparatus. The second date-and-time information may be a time stamp or other information indicating the date and time. The injection molding condition data may include other information in addition to the one or more pieces of injection molding condition information, the apparatus identification information, and the second date-and-time information. The apparatus identification information may be contained in the injection molding condition data as one of the one or more pieces of injection molding condition information. Hereinafter, as an example, a case where the apparatus identification information is contained in the injection molding condition data as one of the one or more pieces of injection molding condition information will be described.

The one or more pieces of injection molding condition information contained in the injection molding condition data acquired from a certain injection molding apparatus include one or more pieces of target value information in addition to the apparatus identification information for identifying the injection molding apparatus. Each of the one or more pieces of target value information is information indicating one or more target values for each control parameter. Therefore, the target value information indicating one or more target values for a certain control parameter is information indicating the injection molding condition, and is associated with the control parameter. A method of associating the control parameter with the target value information may be a known method or a method to be developed. The reason why the one or more pieces of target value information are contained in the injection molding condition data as the injection molding condition information indicating the injection molding condition is that the injection molding apparatus controls the control parameter such that the value of the control parameter matches the target value of the control parameter for each control parameter in each cycle. Here, the reason why there are one or more target values for each control parameter is that there may be a plurality of target values as targets to which each control parameter is to be brought close in the control by the injection molding apparatus in each cycle. For example, the injection speed as the speed at which the material is injected into the cavity in the mold by the screw changes in a plurality of stages in the injection molding step in each cycle. In this case, there are a plurality of target values for the control parameter. The target value information for a certain control parameter indicates each of one or more target values for the control parameter. Therefore, the injection molding condition data includes, as the injection molding condition information, each of the same number of pieces of target value information as the number of measurement units that measure the measurement values of the control parameters among one or more measurement units attached to the injection molding apparatus. Hereinafter, for convenience of description, each of one or more target values for a certain control parameter will be referred to as a target value corresponding to the control parameter. Therefore, hereinafter, for convenience of description, the control parameter will be referred to as a control parameter corresponding to the one or more target values.

The one or more pieces of injection molding condition information in the injection molding condition data acquired from the certain injection molding apparatus include abnormality determination condition information associated with each target value set as the injection molding condition in the injection molding apparatus, in addition to the apparatus identification information for identifying the injection molding apparatus and the one or more pieces of target value information. The abnormality determination condition information associated with a certain target value is information indicating an abnormality determination condition satisfied by the measurement value of the control parameter when no abnormality occurs in the measurement value of the control parameter in the control to match the measurement value of the control parameter corresponding to the target value with the target value by the injection molding apparatus. A method of associating the target value with the abnormality determination condition information may be a known method or a method to be developed. The abnormality determination condition may be any condition as long as the condition is satisfied by the value of the control parameter when no abnormality occurs in the value of the control parameter in the control.

The one or more pieces of injection molding condition information in the injection molding condition data acquired from a certain injection molding apparatus may include other information in addition to the apparatus identification information for identifying the injection molding apparatus, the one or more pieces of target value information, and the abnormality determination condition information associated with each target value set as the injection molding condition in the injection molding apparatus.

The injection molding condition data as described above can be discriminated by a combination of the apparatus identification information and the second date-and-time information. When there is only one injection molding apparatus coupled to the information processing device 20, the injection molding condition data may not include the apparatus identification information. This is because, in this case, each piece of injection molding condition data can be discriminated simply by the second date-and-time information.

When acquiring certain injection molding condition data, the information processing device 20 stores the acquired injection molding condition data and outputs the acquired injection molding condition data to the server 30. Accordingly, the information processing device 20 can also store the acquired injection molding condition data in the server 30. Here, the information processing device 20 performs the following association in the storage area of the information processing device 20 or the storage area of the server 30. That is, the information processing device 20 associates the injection molding condition data indicating the injection molding conditions set in a certain injection molding apparatus in a certain cycle with the cycle data acquired from the injection molding apparatus in the cycle. Such an association method may be a known method or may be a method to be developed. By the association, at least one piece of injection molding condition data is associated with each piece of cycle data. Hereinafter, as an example, a case where one piece of injection molding condition data is associated with each piece of cycle data will be described.

Here, for example, in each of the information processing device 20 and the server 30, certain cycle data can be associated with injection molding condition data including second date-and-time information indicating date and time closest to the date and time indicated by first date-and-time information among dates and times before the date and time indicated by the first date-and-time information contained in the cycle data. This is because the injection molding condition data includes injection molding condition information indicating the injection molding condition set in the injection molding apparatus in the cycle in which the cycle data is acquired by the information processing device 20. Accordingly, each of the information processing device 20 and the server 30 can specify the injection molding condition set in the injection molding apparatus in the cycle. Therefore, hereinafter, a combination of certain cycle data and injection molding condition data associated with the cycle data will be referred to as output data. That is, the information processing device 20 and the server 30 store the combination as output data. Therefore, the information processing device 20 acquiring each of the cycle data and the injection molding condition data may be interpreted as the information processing device 20 acquiring each of the cycle data and the injection molding condition data as the output data. In the first place, when acquiring the cycle data, the information processing device 20 may acquire, as the output data from the injection molding apparatus, a combination of the cycle data to be acquired and the injection molding condition data including the injection molding condition information indicating the injection molding condition set in the injection molding apparatus at the time of acquiring the cycle data. Therefore, hereinafter, for convenience of description, acquisition of cycle data by the information processing device 20 will be referred to as acquisition of output data. Note that any format may be used as the storage format of the output data in one or both of the information processing device 20 and the server 30. That is, one or both of the information processing device 20 and the server 30 may be configured to actually store the combination as output data, may be configured to store a correspondence relationship by which the combination can be specified together with one or more pieces of cycle data and one or more pieces of injection molding condition data, or may be configured to specify the combination as necessary. However, in the present embodiment, even when any one of these configurations is implemented, the fact that one or both of the information processing device 20 and the server 30 can specify the combination is referred to as that one or both of the information processing device 20 and the server 30 store the output data.

In response to a request from the terminal device communicably coupled to the information processing device 20, the information processing device 20 displays various images based on the data stored in the information processing device 20 on the display unit of the terminal device. Here, the images include a graphical user interface (GUI), an icon, and a window on an operating system (OS). Hereinafter, as an example, a case where the information processing device 20 is communicably coupled to a terminal device 40 as shown in FIG. 1 will be described. In the present embodiment, since processing related to login to the information processing device 20 via the terminal device 40 is known processing, a description thereof will be omitted. Hereinafter, for convenience of description, the information processing device 20 receiving an operation from the terminal device 40 via an image displayed on the terminal device 40 is simply referred to as the information processing device 20 receiving an operation. That is, hereinafter, the information processing device 20 performing certain processing according to a received operation refers to the information processing device 20 performing the processing according to the operation received from the terminal device 40 via the image displayed on the terminal device 40.

Examples of the information processing device 20 include, but are not limited to, a workstation, a desktop personal computer (PC), and a notebook PC. The information processing device 20 is communicably coupled to each of the plurality of managed devices 10 by wired or wireless communication. Examples of the communication network that connects the information processing device 20 and the plurality of managed devices 10 include, but are not limited to, a Local Area Network (LAN) in a facility in which the plurality of managed devices 10 are installed. The communication network may be another communication network such as the Internet or a mobile communication network.

The server 30 stores the cycle data acquired by the information processing device 20. For example, when acquiring certain cycle data from the information processing device 20, the server 30 stores the acquired cycle data.

The server 30 stores the injection molding condition data acquired by the information processing device 20. For example, when acquiring certain injection molding condition data from the information processing device 20, the server 30 stores the acquired injection molding condition data.

In response to a request from a terminal device communicably coupled to the server 30, the server 30 displays various images based on the data stored in the server 30 on the display unit of the terminal device. Here, the images include a GUI, an icon, and a window on an OS. Hereinafter, as an example, a case where the server 30 is communicably coupled to the terminal device 40 as shown in FIG. 1 will be described. In the present embodiment, since processing related to login to the server 30 via the terminal device 40 is known processing, a description thereof will be omitted. Hereinafter, for convenience of description, the server 30 receiving an operation from the terminal device 40 via the image displayed on the terminal device 40 is simply referred to as the server 30 receiving an operation. That is, hereinafter, the server 30 performing certain processing according to a received operation refers to the server 30 performing the processing according to the operation received from the terminal device 40 via the image displayed on the terminal device 40.

As described above, in the molding management system 1, both the information processing device 20 and the server 30 display various images based on the stored data on the display unit of the terminal device 40 according to the received operation. Examples of the display unit include, but are not limited to, a display of the terminal device 40 and a display device communicably coupled to the terminal device 40. Hereinafter, as an example, a case where the display unit is the display of the terminal device 40 will be described. Hereinafter, for convenience of description, displaying a certain image on the display unit is referred to as displaying the image.

Here, in the injection molding by the injection molding apparatus, the quality of the product changes according to changes in the mold, the material used for the injection molding of the product, the environment around the injection molding apparatus, and the like. This is because the optimum injection molding condition for injection molding a high-quality product differs depending on the mold, the material used for injection molding of the product, the environment around the injection molding apparatus, and the like. FIG. 2 is an image diagram of a flow in which the quality of a product injection-molded by the injection molding apparatus changes when the injection molding condition is changed. As shown in FIG. 2, in the injection molding by the injection molding apparatus, when the injection molding condition is changed, the measurement value of the management item changes. As described above, the management item is correlated with the quality of the product. Therefore, when the measurement value changes, the quality of the product also changes. This means that the injection molding condition is required to be changed when the quality of the product deteriorates. FIG. 3 is an image diagram of a flow in which the injection molding condition is required to be changed when the quality of the product deteriorates. As shown in FIG. 3, in the injection molding by the injection molding apparatus, for example, when the quality of the product starts to deteriorate according to a change in the environment around the injection molding apparatus or the like, the measurement value starts to deviate from the target value of the management item, and as a result, the measurement value starts to deviate from an allowable range allowable as a deviation from the target value. This means that the injection molding condition set in the injection molding apparatus deviates from the optimum injection molding condition according to the change in the environment around the injection molding apparatus or the like, and the injection molding condition is required to be changed. Note that the allowable range is a range determined by the user of the information processing device 20, and is, for example, a range between a value predetermined as the upper management limit value and a value predetermined as the lower management limit value, but is not limited thereto, and may be a range between a value predetermined as the upper standard limit value and a value predetermined as the lower standard limit value. Here, the upper management limit value is a limit value allowable for management of the quality of the product as an upward deviation of the measurement value from the target value, and is a value determined by a manager or the like who manages injection molding by the injection molding apparatus. The lower management limit value is a limit value allowable for management of the quality of the product as a downward deviation of the measurement value from the target value, and is a value determined by a manager or the like who manages injection molding by the injection molding apparatus. The upper standard limit value is a limit value at which the product can be treated as a non-defective product as an upward deviation of the measurement value from the target value, and is a value determined by the standard of the product. The lower standard limit value is a limit value at which the product can be treated as a non-defective product as a downward deviation of the measurement value from the target value, and is a value determined by the standard of the product.

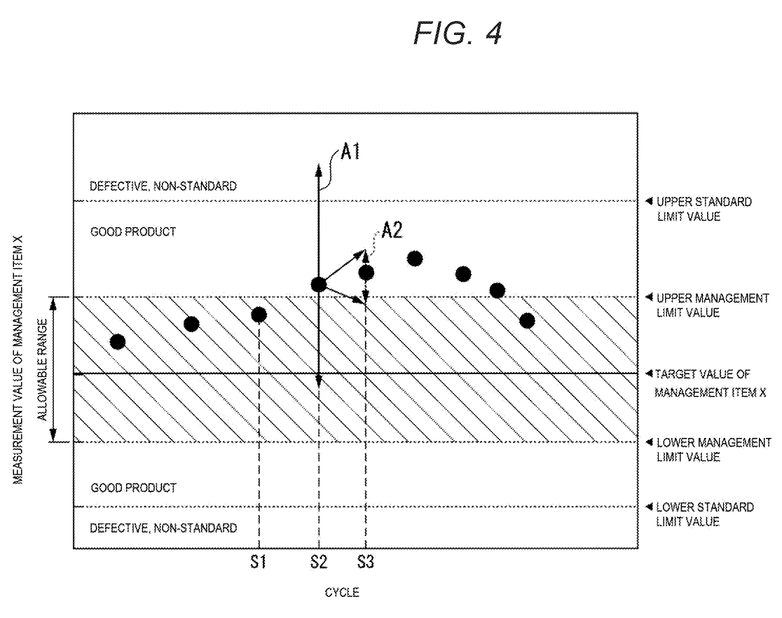

In anticipation of the requirement to change the injection molding conditions, in the related art, various methods have been proposed for changing the injection molding conditions set in the injection molding apparatus when the measurement value of the management item deviates from the allowable range allowable as a deviation from the target value of the management item. However, in the methods, the measurement value may deviate away from the target value due to a change in the injection molding condition. This is because a probabilistic method may be used as the method for generating the optimum injection molding condition. In this case, when there is no restriction on the amount of change in the measurement value that changes due to the change in the injection molding condition, the measurement value may significantly deviate away from the target value. The problem can be solved by, for example, a method of setting a maximum allowable change amount that is allowable as the amount of change. FIG. 4 shows an example of a change in the measurement value of a certain management item X for each cycle when the injection molding apparatus continuously executes a plurality of cycles. The horizontal axis of the graph shown in FIG. 4 indicates each cycle according to the order of execution of each cycle in continuous execution of the plurality of cycles. The vertical axis of the graph indicates the measurement value. The graph shows the target value of the management item X together with each of the upper management limit value, the lower management limit value, the upper standard limit value, and the lower standard limit value described above. In the example shown in FIG. 4, the allowable range is a range between the upper management limit value and the lower management limit value.

In the example shown in FIG. 4, in a cycle S1, the measurement value of the management item X deviates upward from the target value, but falls in the allowable range. In contrast, in the example, in a cycle S2 executed after the cycle S1, the measurement value deviates upward from the allowable range. Therefore, in the method of the related art, the injection molding condition is changed in a cycle S3 and the subsequent cycles executed after the cycle S2. As a result, the measurement value changes closer to the target value or away from the target value. Here, when there is no restriction on the change of the injection molding condition, the measurement value changes, for example, within a range indicated by an arrow A1 shown in FIG. 4. In this case, when the measurement value changes away from the target value, the measurement value may change upward from the target value over the upper standard limit value. This leads to deterioration of the yield of products injection-molded by the injection molding apparatus, which is not desirable. On the other hand, when a restriction is imposed on the change of the injection molding condition such that the change amount of the measurement value does not exceed the maximum allowable change amount, the measurement value changes, for example, within a range indicated by an arrow A2 shown in FIG. 4. In this case, even when the measurement value changes away from the target value, the measurement value does not change upward over the upper standard limit value. As a result, in the example shown in FIG. 4, as a result of changing the injection molding condition for each execution of each of the four cycles after the cycle S3, the measurement value returns to a value within the allowable range. That is, in the related art, as the maximum allowable change amount is set to a smaller amount, it is possible to further prevent the measurement value from significantly deviating from the target value. This corresponds to a case where the amount of change in the measurement value due to the change in the injection molding condition is set to a small amount, which is natural. However, when the method is used, there are at least two problems of a first problem and a second problem described below.

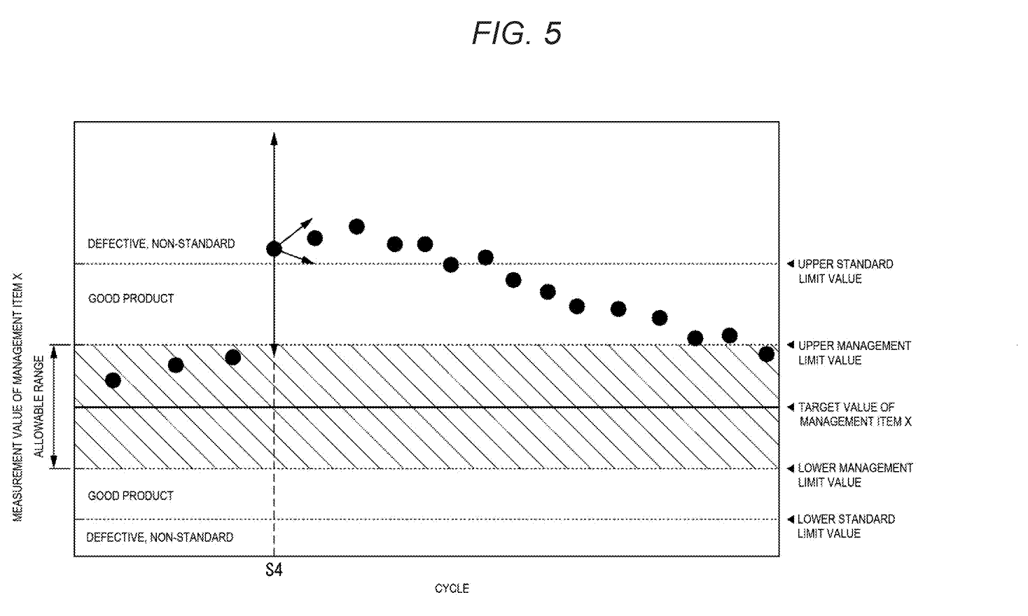

The first problem is caused by a significant deviation of the measurement value of the management item X from the target value. Specifically, the first problem is that, in the case where the measurement value significantly deviates from the target value, when a restriction is imposed such that the change amount of the measurement value does not exceed the maximum allowable change amount, the time required for the measurement value to return to within the allowable range may increase as shown in FIG. 5. FIG. 5 shows another example of the change in the measurement value of the management item X for each cycle when the injection molding apparatus continuously executes a plurality of cycles. The horizontal axis of the graph shown in FIG. 5 indicates each cycle according to the order of execution of each cycle in continuous execution of the plurality of cycles. The vertical axis of the graph indicates the measurement value. The graph shows the target value of the management item X together with each of the upper management limit value, the lower management limit value, the upper standard limit value, and the lower standard limit value described above. In the example shown in FIG. 5, the allowable range is a range between the upper management limit value and the lower management limit value. In the example shown in FIG. 5, in a cycle S4, the measurement value exceeds the upper standard limit value upward from the target value. However, in the example shown in FIG. 5, since a restriction is imposed such that the change amount of the measurement value does not exceed the maximum allowable change amount, 14 cycles are required to return the measurement value to the allowable range. This significantly deteriorates the yield of products injection-molded by the injection molding apparatus, which is not desirable. That is, in other words, the first problem is a problem that, in the case where the measurement value is significantly deviated from the target value, when a restriction is imposed such that the change amount of the measurement value does not exceed the maximum allowable change amount, it is difficult for the measurement value to return to within the allowable range.

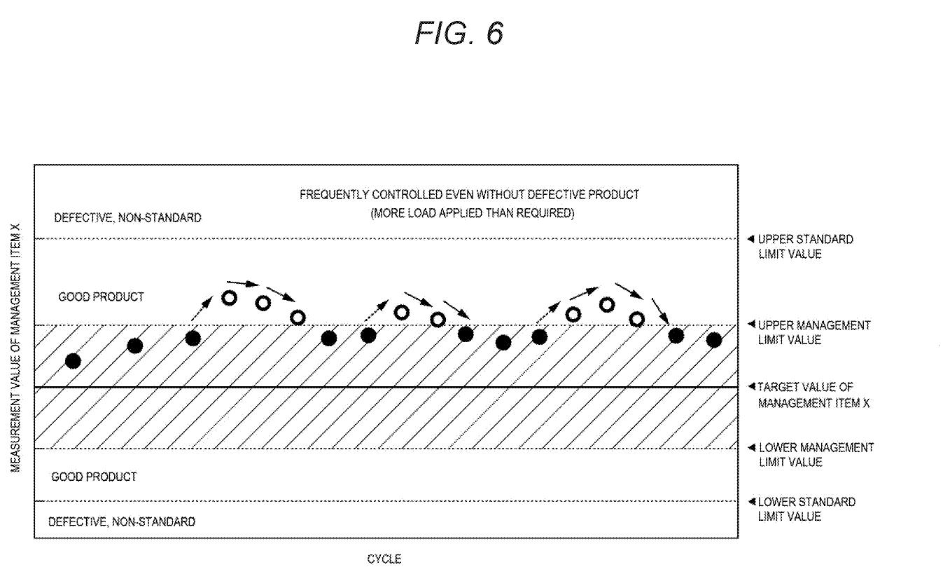

In addition, the second problem is a problem that the measurement value of the management item X vibrates at the boundary between the inside and the outside of the allowable range. Specifically, the second problem is a problem that, in the case where the measurement value slightly deviates from the allowable range, when a restriction is imposed such that the change amount of the measurement value does not exceed the maximum allowable change amount, the measurement value repeatedly goes back and forth between the inside and the outside of the allowable range as shown in FIG. 6. FIG. 6 shows still another example of a change in the measurement value of the management item X for each cycle when the injection molding apparatus continuously executes a plurality of cycles. The horizontal axis of the graph shown in FIG. 6 indicates each cycle according to the order of execution of each cycle in continuous execution of the plurality of cycles. The vertical axis of the graph indicates the measurement value. The graph shows the target value of the management item X together with each of the upper management limit value, the lower management limit value, the upper standard limit value, and the lower standard limit value described above. In the example shown in FIG. 6, the measurement value repeatedly goes back and forth between the inside and the outside of the allowable range three times above the target value. This causes variations in quality of products injection-molded by the injection molding apparatus, which is not desirable. In other words, this destabilizes the injection molding by the injection molding apparatus, which is not desirable.

Therefore, the information processing device 20 receives, for each of one or more management items, a target value of the management item and three ranges of a first allowable range allowed as a deviation of a measurement value of the management item from the target value, a second allowable range allowed as a deviation of the measurement value from the first allowable range, and a target neighborhood range indicating a neighborhood of the target value of the measurement value according to the received operation. In other words, the target neighborhood range is a range indicating that there is almost no deviation of the measurement value from the target value. As a result, the information processing device 20 can solve both of the two problems of the first problem and the second problem as described below. Note that the information processing device 20 may be configured to solve one of the two problems as will be described later. The information processing device 20 performs the same processing as the processing described below for each of one or more management items. Therefore, in order to simplify the description, a case where one or more management items are only the first management item designated by the user will be described below as an example. Examples of the first management item include, but are not limited to, an injection holding pressure and an injection speed.

For example, in order to solve the first problem, the information processing device 20 determines whether the measurement value of the first management item deviates from at least the first allowable range of the first allowable range and the second allowable range based on the acquired output data at each time when acquiring the output data. Then, when determining that the measurement value deviates from the first allowable range and falls between the first allowable range and the second allowable range, the information processing device 20 changes the injection molding condition set in the injection molding apparatus under a restriction of changing the measurement value within the maximum allowable change amount allowable as the amount of change of the measurement value. Here, the maximum allowable change amount is an amount received by the information processing device 20 from the user as an amount smaller than the maximum value of the amount of change of the measurement value of the first management item when the injection molding condition changes with the restriction removed. The maximum allowable change amount is, for example, an amount equal to or less than the absolute value of the difference between the upper limit value of the first allowable range and the upper limit value of the second allowable range, or an amount equal to or less than the absolute value of the difference between the lower limit value of the first allowable range and the lower limit value of the second allowable range. The maximum allowable change amount is an amount obtained by multiplying the absolute value of the difference between the upper limit value of the first allowable range and the target value of the first management item by a predetermined ratio. In this case, for example, the information processing device 20 receives a ratio received by a predetermined operation as the predetermined ratio. The ratio is any ratio desired by the user. Thus, the information processing device 20 can use any ratio as the predetermined ratio. The maximum allowable change amount is not limited thereto, and may be another amount as long as the amount is smaller than the maximum value of the amount of the change of the measurement value of the first management item when the injection molding condition changes with the restriction removed. On the other hand, when the measurement value deviates from both the first allowable range and the second allowable range, the information processing device 20 removes the restriction and changes the injection molding condition set in the injection molding apparatus with the restriction removed. Hereinafter, for convenience of description, the processing based on the determination will be referred to as first processing. Through the first processing, the information processing device 20 can quickly bring the measurement value close to the target value when the measurement value is significantly deviated from the target value, and can prevent the measurement value from being significantly deviated from the target value when the measurement value is slightly deviated from the target value. As a result, the information processing device 20 can prevent an increase in the time required to bring the measurement value close to the target value. A value serving as a reference for determining whether the deviation of the measurement value from the target value is larger or smaller may be interpreted as the maximum allowable change amount. In this case, the deviation of the measurement value from the target value is determined to be larger when the deviation is larger than the maximum allowable change amount, and is determined to be smaller when the deviation is smaller than the maximum allowable change amount. In view of the circumstances, the maximum allowable change amount may be determined by the subjective view of the user regarding the magnitude of the deviation of the measurement value from the target value. Hereinafter, as an example, a case where the first allowable range is a range between the upper management limit value and the lower management limit value will be described. The first allowable range is not limited thereto, and may be another range as long as the range is allowable as a deviation of the measurement value from the target value. Furthermore, hereinafter, as an example, a case where the second allowable range is a range between the upper standard limit value and the lower standard limit value will be described. The second allowable range is not limited thereto, and may be another range as long as the range is allowable as a deviation of the measurement value from the first allowable range. The target neighborhood range is a range contained in the first allowable range. Therefore, the upper limit value of the target neighborhood range is less than the upper limit value of the first allowable range. The lower limit value of the target neighborhood range is larger than the lower limit value of the first allowable range.

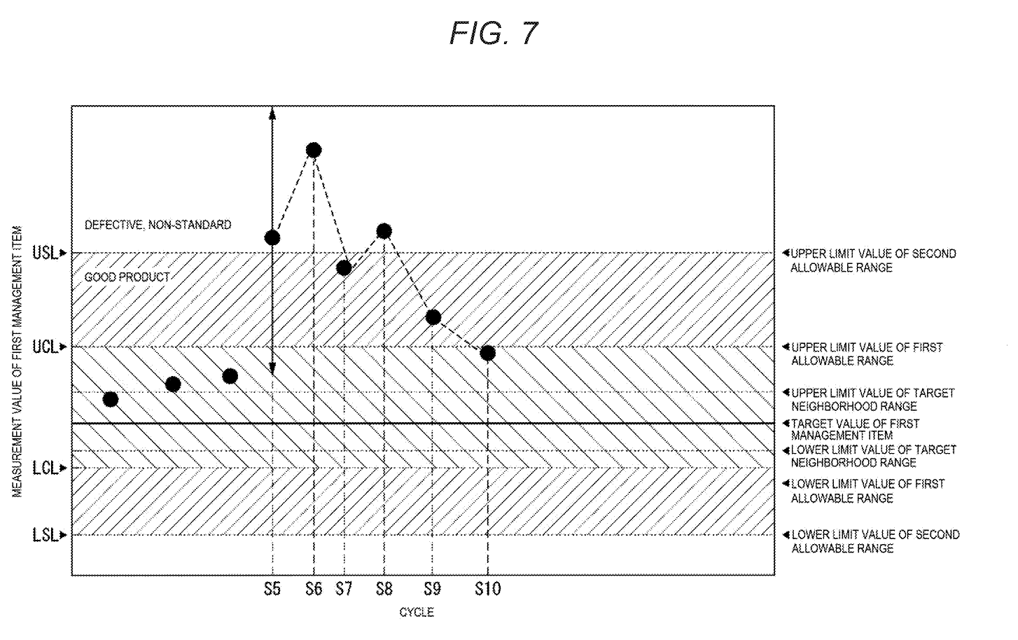

FIG. 7 shows an example of a process in which, when the measurement value of the first management item is significantly deviated from the target value, the measurement value is returned to within the first allowable range by the first processing by the information processing device 20. The horizontal axis of the graph shown in FIG. 7 indicates each cycle according to the order of execution of each cycle in continuous execution of the plurality of cycles. The vertical axis of the graph indicates the measurement value. The graph shows the upper limit value of the second allowable range, the upper limit value of the first allowable range, the upper limit value of the target neighborhood range, the target value of the first management item, the lower limit value of the target neighborhood range, the lower limit value of the first allowable range, and the lower limit value of the second allowable range described above.

In the example shown in FIG. 7, the measurement value of the first management item acquired in a cycle S5 exceeds the upper limit value of the second allowable range upward from the target value. In this case, for example, before executing a cycle S6, the information processing device 20 removes the restriction of changing the measurement value within the maximum allowable change amount described above, and changes the injection molding condition set in the injection molding apparatus with the restriction removed. Then, the information processing device 20 causes the injection molding apparatus to execute the cycle S6. However, in this case, the measurement value is not necessarily closer to the target value. In this example, the measurement value acquired in the cycle S6 is farther away from the target value. Also in this case, since the measurement value exceeds the upper limit value of the second allowable range, the information processing device 20 changes the injection molding condition set in the injection molding apparatus with the restriction removed even before executing a cycle S7. Then, the information processing device 20 causes the injection molding apparatus to execute the cycle S7. As a result, in the example, the measurement value acquired in the cycle S7 changes from a value above the upper limit value of the second allowable range to a value between the upper limit value of the second allowable range and the upper limit value of the first allowable range. In this case, before executing a cycle S8, for example, the information processing device 20 imposes the restriction and changes the injection molding condition set in the injection molding apparatus under the restriction. Then, the information processing device 20 causes the injection molding apparatus to execute the cycle S8. As a result, in the example, the measurement value exceeds the upper limit value of the second allowable range again. However, since the amount of change in the measurement value is small due to the restriction, the measurement value acquired in the cycle S8 does not significantly change upward from the upper limit value of the second allowable range. However, in the cycle S8, since the fact that the measurement value changes above the upper limit value of the second allowable range remains, before executing a cycle S9, for example, the information processing device 20 removes the restriction, and changes the injection molding condition set in the injection molding apparatus with the restriction removed. Then, the information processing device 20 causes the injection molding apparatus to execute the cycle S9. As a result, in the example, the measurement value acquired in the cycle S9 changes from a value above the upper limit value of the second allowable range to a value between the upper limit value of the second allowable range and the upper limit value of the first allowable range. Here, the measurement value in the cycle S9 is a value close to the upper limit value of the first allowable range, but is still a value above the upper limit value of the first allowable range. Therefore, before executing a cycle S10, for example, the information processing device 20 imposes the restriction, and changes the injection molding condition set in the injection molding apparatus under the restriction. Then, the information processing device 20 causes the injection molding apparatus to execute the cycle S10. As a result, in the example, the measurement value acquired in the cycle S10 changes from a value above the upper limit value of the first allowable range to a value between the upper limit value of the first allowable range and the target value. As described above, when determining that the measurement value deviates from the first allowable range and falls between the first allowable range and the second allowable range, the information processing device 20 changes the injection molding condition set in the injection molding apparatus under the restriction of changing the measurement value within the maximum allowable change amount. On the other hand, when the measurement value deviates from both the first allowable range and the second allowable range, the information processing device 20 removes the restriction and changes the injection molding condition set in the injection molding apparatus with the restriction removed. Thus, the information processing device 20 can prevent an increase in the time required to bring the measurement value close to the target value. Actually, in the example shown in FIG. 7, the measurement value changes to a value between the upper limit value of the first allowable range and the target value by executing the five cycles of the cycle S6 and the subsequent cycles. This indicates that the time required to bring the measurement value of the first management item close to the target value can be shortened as compared with the case where the measurement value of the management item X is returned to within the allowable range by executing the 14 cycles shown in FIG. 5. That is, the information processing device 20 can solve the first problem by the first processing.

For example, in order to solve the second problem, the information processing device 20 determines whether the measurement value of the first management item deviates from the first allowable range based on the acquired output data at each time when acquiring the output data. When determining that the measurement value deviates from the first allowable range in the determination, the information processing device 20 changes the injection molding condition set in the injection molding apparatus, changes the injection molding condition set in the injection molding apparatus until the device determines in the subsequent determination that the measurement value falls within the target neighborhood range at each time when making the determination, and when determining in the determination that the measurement value falls within the target neighborhood range, stops changing the injection molding condition set in the injection molding apparatus until the device determines in the determination again that the measurement value deviates from the first allowable range. Hereinafter, for convenience of description, the processing based on the determination will be referred to as second processing. Through the second processing, the information processing device 20 can prevent the vibration of the measurement value near the upper limit value or the lower limit value of the first allowable range, and can more reliably bring the measurement value closer to the target value. As a result, the information processing device 20 can improve the stability of injection molding by the injection molding apparatus while preventing deterioration in the quality of the product.

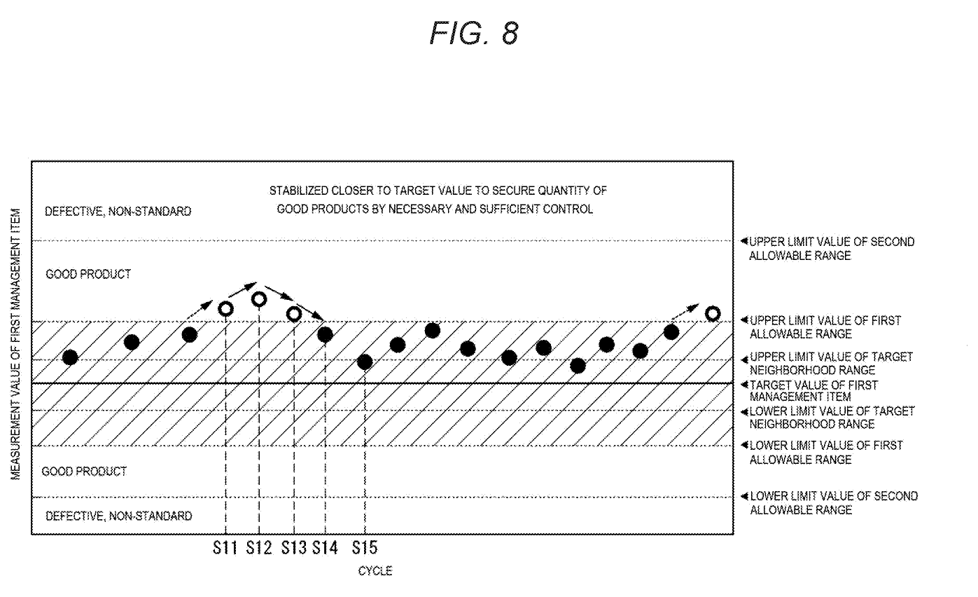

FIG. 8 shows an example of a process in which, when the measurement value of the first management item deviates from the first allowable range, the measurement value is changed to a value within the target neighborhood range by the second processing by the information processing device 20. The horizontal axis of the graph shown in FIG. 8 indicates each cycle according to the order of execution of each cycle in continuous execution of the plurality of cycles. The vertical axis of the graph indicates the measurement value. The graph shows the upper limit value of the second allowable range, the upper limit value of the first allowable range, the upper limit value of the target neighborhood range, the target value of the first management item, the lower limit value of the target neighborhood range, the lower limit value of the first allowable range, and the lower limit value of the second allowable range described above.

In the example shown in FIG. 8, the measurement value of the first management item acquired in a cycle S11 exceeds the upper limit value of the first allowable range upward. In this case, for example, before executing a cycle S12, the information processing device 20 changes the injection molding condition set in the injection molding apparatus. Then, the information processing device 20 causes the injection molding apparatus to execute the cycle S12. However, in this case, the measurement value is not necessarily closer to the target value. In the example, the measurement value acquired in the cycle S12 is away from the target value further above. Also in this case, since the measurement value exceeds the first allowable range, before executing a cycle S13, the information processing device 20 changes the injection molding condition set in the injection molding apparatus. Then, the information processing device 20 causes the injection molding apparatus to execute the cycle S13. As a result, in the example, the measurement value acquired in the cycle S13 is closer to the target value. However, although the measurement value is a value close to the upper limit value of the first allowable range in the cycle S13, the measurement value is still a value above the upper limit value of the first allowable range. Therefore, before executing a cycle S14, the information processing device 20 changes the injection molding conditions set in the injection molding apparatus. Then, the information processing device 20 causes the injection molding apparatus to execute the cycle S14. Here, in the method of the related art, the change of the injection molding conditions set in the injection molding apparatus is stopped at this stage. In contrast, since the measurement value is not a value within the target neighborhood range, the information processing device 20 changes the injection molding condition set in the injection molding apparatus also before executing the cycle S15. Thus, in this example, in the cycle S15, the measurement value changes to a value within the target neighborhood range. As a result, as shown in FIG. 8, the information processing device 20 can prevent the measurement value from vibrating so as to go back and forth between the inside and the outside of the first allowable range. The fact that the measurement value shown in FIG. 8 does not vibrate so as to go back and forth between the inside and the outside of the first allowable range should be clearly understood by comparison with the fact that the measurement value of the management item X shown in FIG. 6 vibrates so as to go back and forth between the inside and the outside of the allowable range. That is, the information processing device 20 can solve the second problem by the second processing.

Then, in the present embodiment, the information processing device 20 collectively performs the first processing and the second processing. As a result, the information processing device 20 can solve both the first problem and the second problem. The information processing device 20 may be configured to perform the first processing and not to perform the second processing. In this case, the information processing device 20 can solve the first problem, but cannot solve the second problem. On the other hand, the information processing device 20 may be configured to perform the second processing and not to perform the first processing. In this case, the information processing device 20 can solve the second problem, but cannot solve the first problem.

### Hardware Configuration of Information Processing Device

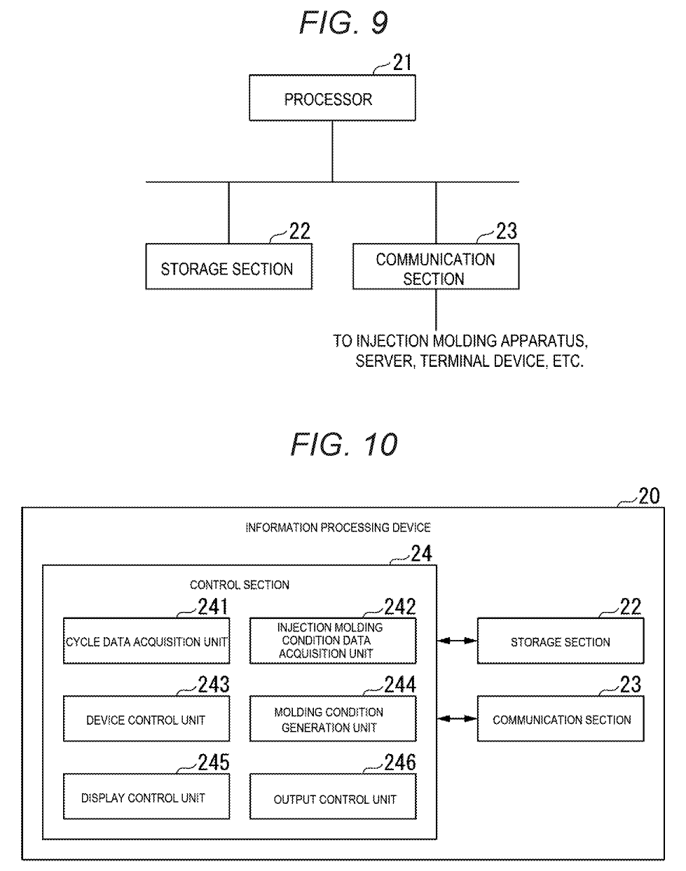

Hereinafter, a hardware configuration of the information processing device 20 will be described with reference to FIG. 9. FIG. 9 shows an example of the hardware configuration of the information processing device 20.

The information processing device 20 includes, for example, a processor 21, a storage section 22, and a communication section 23. These component elements are communicably coupled to one another via a bus. The information processing device 20 communicates with other devices via the communication section 23. The other devices include, for example, an injection molding apparatus, the server 30, the terminal device 40, or the like.

The processor 21 is, for example, a central processing unit (CPU). Instead of the CPU, the processor 21 may be another processor such as a field programmable gate array (FPGA). The processor 21 executes various programs stored in the storage section 22.

The storage section 22 is, for example, a storage device including a hard disk drive (HDD), a solid-state drive (SSD), an electrically erasable programmable read-only memory (EEPROM), a read-only memory (ROM), and a random access memory (RAM). Instead of being built in the information processing device 20, the storage section 22 may be an external storage device coupled to a digital input and output port such as a universal serial bus (USB). The storage section 22 stores various types of information, various images, and various programs to be processed by the information processing device 20. That is, the various types of information stored in the information processing device 20 are stored in the storage section 22. For example, the above-described output data is stored in the storage section 22.

The communication section 23 is a communication device including, for example, a digital input and output port such as a USB, an Ethernet (registered trademark) port, and an antenna for wireless communication.

### Functional Configuration of Information Processing Device

Hereinafter, a functional configuration of the information processing device 20 will be described with reference to FIG. 10. FIG. 10 shows an example of the functional configuration of the information processing device 20.

The information processing device 20 includes the storage section 22, the communication section 23, and a control section 24.

The control section 24 controls the entire information processing device 20. The control section 24 includes at least a cycle data acquisition unit 241, an injection molding condition data acquisition unit 242, a device control unit 243, a molding condition generation unit 244, a display control unit 245, and an output control unit 246. These functional units provided in the control section 24 are implemented by, for example, the processor 21 executing the various programs stored in the storage section 22. Some or all of the functional units may be hardware functional units such as a large scale integration (LSI) or an application specific integrated circuit (ASIC).

The cycle data acquisition unit 241 acquires the cycle data for each cycle of the injection molding apparatus from the injection molding apparatus communicably coupled to the information processing device 20.

The injection molding condition data acquisition unit 242 acquires the injection molding condition data from the injection molding apparatus communicably coupled to the information processing device 20 at each time when the injection molding condition is set in the injection molding apparatus.

The device control unit 243 controls the injection molding apparatus coupled to the information processing device 20 according to the received operation.

The molding condition generation unit 244 generates an injection molding condition.

The display control unit 245 generates various images according to the received operation. The display control unit 245 transmits the generated images to the terminal device 40 and displays the images on the terminal device 40.

The output control unit 246 outputs various types of data to another device according to the received operation.

Processing of Setting Injection Molding Condition in Injection Molding Apparatus by Information Processing Device

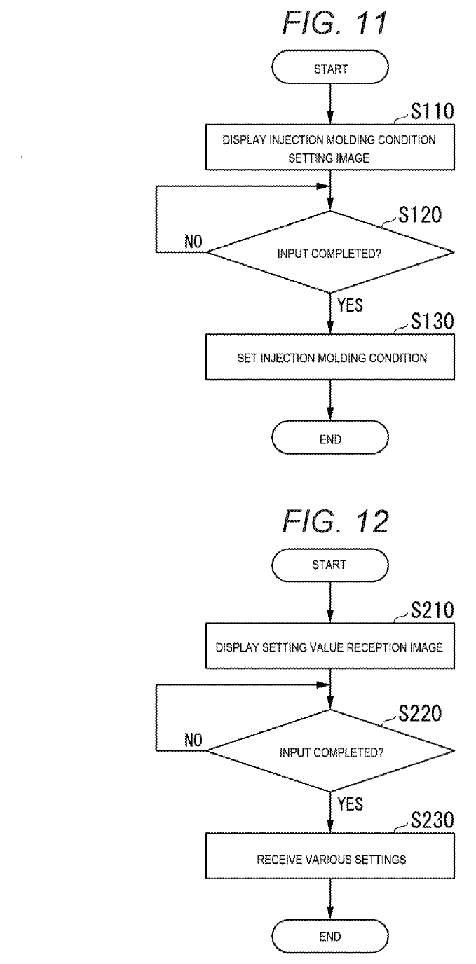

Referring to FIG. 11, processing of setting an injection molding condition in the injection molding apparatus by the information processing device 20 will be described. FIG. 11 shows an example of a flow of processing of setting an injection molding condition in the injection molding apparatus by the information processing device 20. Hereinafter, as an example, a case where an operation of displaying an injection molding condition setting image is received at a timing before the processing in step S110 shown in FIG. 11 is performed will be described. The injection molding condition setting image is an image including an image for receiving various injection molding conditions to be set in the injection molding apparatus coupled to the information processing device 20 and an image for receiving an operation of setting various injection molding conditions received by the image in the injection molding apparatus.

After receiving the operation of displaying the injection molding condition setting image, the display control unit 245 displays the injection molding condition setting image (step S110).

Then, the display control unit 245 waits until input of various injection molding conditions to the injection molding condition setting image is completed (step S120). In FIG. 11, the processing in step S120 is indicated by "INPUT COMPLETED?". Here, for example, when receiving an operation of setting various injection molding conditions received by an image for receiving various injection molding conditions set in the injection molding apparatus coupled to the information processing device 20 in the injection molding apparatus is received via the injection molding condition setting image, the display control unit 245 determines that the input of various injection molding conditions to the injection molding condition setting image is completed. On the other hand, for example, when not receiving the operation via the injection molding condition setting image, the unit determines that the input of various injection molding conditions to the injection molding condition setting image is not completed.

When determining that the input of various injection molding conditions to the injection molding condition setting image is completed (step S120-YES), the display control unit 245 receives the injection molding conditions input to the injection molding condition setting image as the injection molding conditions to be set in the injection molding apparatus, and sets the received injection molding conditions in the injection molding apparatus (step S130). The method of setting the injection molding conditions in the injection molding apparatus by the information processing device 20 may be a known method or a method to be developed. After the processing in step S130 is performed, the information processing device 20 ends the processing of the flowchart shown in FIG. 11.

Here, the injection molding condition set in the injection molding apparatus by the processing of the flowchart shown in FIG. 11 may be an injection molding condition generated based on a response surface, a function, a regression model, a machine learning model, or the like calculated by the information processing device 20, or may be an injection molding condition determined for some other reason.

As described above, the information processing device 20 can set the injection molding condition in the injection molding apparatus according to the received operation.

Processing of Receiving Various Settings by Information Processing Device

Referring to FIG. 12, processing of receiving various settings by the information processing device 20 will be described. Here, the various settings include at least a setting of each of the upper limit value of the first allowable range, the lower limit value of the first allowable range, the upper limit value of the second allowable range, the lower limit value of the second allowable range, the upper limit value of the target neighborhood range, the lower limit value of the target neighborhood range, and the maximum allowable change amount, and a setting of designating one or more desired settable parameters as management items and target values thereof. Note that the various settings may include other settings. FIG. 12 shows an example of a flow of processing of receiving various settings by the information processing device 20. Hereinafter, as an example, a case where an operation of displaying a setting reception image is received at a timing before the processing in step S210 shown in FIG. 12 is performed will be described. The setting reception image is an image including an image in which the information processing device 20 receives various settings. More specifically, the setting reception image is an image including an image for receiving each of the upper limit value of the first allowable range, the lower limit value of the first allowable range, the upper limit value of the second allowable range, the lower limit value of the second allowable range, the upper limit value of the target neighborhood range, the lower limit value of the target neighborhood range, and the maximum allowable change amount, and an image for receiving one or more settable parameters desired to be designated by the user as the management items and the target values thereof.

After receiving the operation of displaying the setting reception image, the display control unit 245 displays the setting reception image (step S210).

Then, the display control unit 245 waits until input of various settings to the setting reception image is completed (step S220). In FIG. 12, the processing in step S220 is indicated by "INPUT COMPLETED?". More specifically, in step S220, the display control unit 245 waits until the seven values of the upper limit value of the first allowable range, the lower limit value of the first allowable range, the upper limit value of the second allowable range, the lower limit value of the second allowable range, the upper limit value of the target neighborhood range, the lower limit value of the target neighborhood range, and the maximum allowable change amount are input to the image in which the seven values are to be input, and the one or more settable parameters desired to be designated as the management item by the user are input via the image in which the one or more settable parameters and the target values thereof are to be input. For example, when all the input is completed, the display control unit 245 determines that the input of various settings to the setting reception image is completed. In contrast, for example, when at least some of the input is not completed, the display control unit 245 determines that the input of various settings to the setting reception image is not completed. Here, the display control unit 245 may be configured, in a case where the upper limit value and the lower limit value of the first allowable range are received with unilateral tolerance in the setting reception image, when one of the upper limit value and the lower limit value of the first allowable range is input, to automatically input 0 as the other of the upper limit value and the lower limit value of the first allowable range. Similarly, the display control unit 245 may be configured, in a case where the upper limit value and the lower limit value of the second allowable range are received with unilateral tolerance in the setting reception image, when one of the upper limit value and the lower limit value of the second allowable range is input, to automatically input 0 as the other of the upper limit value and the lower limit value of the second allowable range. Furthermore, similarly, the display control unit 245 may be configured, in a case where the upper limit value and the lower limit value of the target neighborhood range are received with unilateral tolerance in the setting reception image, when one of the upper limit value and the lower limit value of the target neighborhood range is input, to automatically input 0 as the other of the upper limit value and the lower limit value of the target neighborhood range.

When determining that the input of various settings to the setting reception image is completed (step S220-YES), the display control unit 245 receives the various settings input to the setting reception image (step S230). After the processing in step S230 is performed, the information processing device 20 ends the processing of the flowchart shown in FIG. 12.

As described above, the information processing device 20 can receive various settings according to the received operation. Specifically, the information processing device 20 can receive each of the upper limit value of the first allowable range, the lower limit value of the first allowable range, the upper limit value of the second allowable range, the lower limit value of the second allowable range, and the maximum allowable change amount, and one or more desired settable parameters as management items by the processing of the flowchart as described above. Accordingly, the information processing device 20 can specify the first allowable range and the second allowable range, and can specify the management item and the target value thereof.

The setting reception image may be an image integrally configured with the injection molding condition setting image. In this case, for example, in step S120 shown in FIG. 11, the information processing device 20 performs the processing in step S220 shown in FIG. 12 together with the processing in step S120. In this case, for example, in step S130, the information processing device 20 performs processing in step S130 and the processing in step S230.

Processing of Causing Injection Molding Apparatus to Perform Injection Molding by Information Processing Device

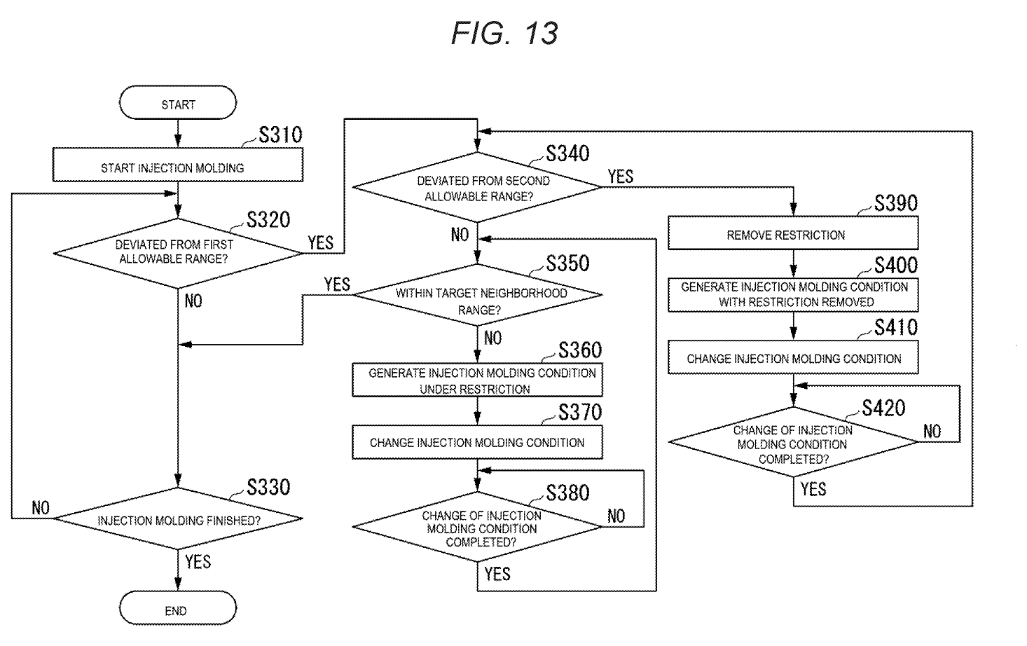

Referring to FIG. 13, processing of causing the injection molding apparatus to perform injection molding by the information processing device 20 will be described. FIG. 13 shows an example of a flow of processing of causing the injection molding apparatus to perform injection molding by the information processing device 20. Hereinafter, as an example, a case where, in order to cause the injection molding apparatus to perform injection molding at a timing before the processing in step S310 shown in FIG. 13 is performed, a cycle execution operation for causing the injection molding apparatus to execute a cycle at a number of cycle executions received in advance as the number of times of execution of the cycle is received will be described. Furthermore, hereinafter, as an example, a case where the processing of the flowcharts shown in FIGS. 11 and 12 have been executed at the timing will be described.

After receiving the cycle execution operation, the device control unit 243 starts to cause the injection molding apparatus to execute the cycle at the number of cycle executions (step S310). In FIG. 13, the processing in step S310 is indicated by "START INJECTION MOLDING".

Then, the device control unit 243 waits until the execution of the cycle currently executed by the injection molding apparatus is completed. Then, when the execution of the cycle is completed, the device control unit 243 performs determination based on the output data acquired in the cycle, that is, based on the latest output data stored in the storage section 22. Specifically, the device control unit 243 specifies the measurement value of the first management item indicated by the measurement value information contained in the output data as a target measurement value used in the determination processing using the measurement value in the flowchart shown in FIG. 13, and determines whether the specified target measurement value deviates from the first allowable range (step S320). In FIG. 13, the processing in step S320 is indicated by "DEVIATED FROM FIRST ALLOWABLE RANGE?". The target measurement value deviating from the first allowable range means that the target measurement value is a value larger than the upper limit value of the first allowable range or that the target measurement value is a value smaller than the lower limit value of the first allowable range.

When determining that the target measurement value does not deviate from the first allowable range (step S320-NO), the device control unit 243 determines whether the cycle at the number of cycle executions started by the injection molding apparatus in step S310 is finished (step S330). In FIG. 13, the processing in step S330 is indicated by "INJECTION MOLDING FINISHED?". Note that the method by which the device control unit 243 performs the processing in step S330 may be a known method or a method to be developed.

When determining that the cycle at the number of cycle executions started by the injection molding apparatus in step S310 is finished (step S330-YES), the device control unit 243 ends the processing of the flowchart shown in FIG. 13.

On the other hand, when determining that the cycle at the number of cycle executions started by the injection molding apparatus in step S310 is not finished (step S330-NO), the device control unit 243 transitions to step S320 and waits again until the execution of the cycle currently executed by the injection molding apparatus is completed. Then, when the execution of the cycle is completed, the device control unit 243 performs determination based on the output data acquired in the cycle, that is, based on the latest output data stored in the storage section 22.

On the other hand, when determining that the target measurement value deviates from the first allowable range (step S320-YES), the device control unit 243 determines whether the target measurement value also deviates from the second allowable range (step S340). In FIG. 13, the processing in step S340 is indicated by "DEVIATED FROM SECOND ALLOWABLE RANGE?". The target measurement value deviating from the second allowable range means that the target measurement value is a value larger than the upper limit value of the second allowable range or that the target measurement value is a value smaller than the lower limit value of the second allowable range.

When determining that the target measurement value does not deviate from the second allowable range (step S340-NO), the device control unit 243 determines whether the target measurement value is a value within the target neighborhood range (step S350). In FIG. 13, the processing in step S350 is indicated by "WITHIN TARGET NEIGHBORHOOD RANGE?". Here, the target measurement value used in the processing in step S350 is the target measurement value specified by the device control unit 243 in step S320 when the device control unit 243 executes the processing in step S350 by the transition from step S340. In contrast, the target measurement value used in the processing in step S350 is the measurement value of the first management item indicated by the measurement value information contained in the output data first acquired from the injection molding apparatus after the change of the injection molding condition is completed in step S380, which will be described later, when the device control unit 243 executes the processing in step S350 by the transition from step S380. Therefore, at the time of the first execution of the processing in step S350, the device control unit 243 automatically transitions to step S360 without transitioning to step S330. When the restriction of changing the measurement value of the first management item within the maximum allowable change amount is removed in step S350, the device control unit 243 imposes the restriction again.

When determining that the target measurement value is a value within the target neighborhood range (step S350-YES), the device control unit 243 determines that the target measurement value is sufficiently close to the target value, exits the repetitive processing of steps S350 to S380, transitions to step S330, and determines again whether the cycle at the number of cycle executions started by the injection molding apparatus in step S310 is finished. Accordingly, the information processing device 20 can stop changing the injection molding condition set in the injection molding apparatus until it is determined again that the target measurement value deviates from the first allowable range in the determination in step S320. Therefore, the information processing device 20 does not change the injection molding condition set in the injection molding apparatus even when it is determined that the measurement value of the first management item falls between the first allowable range and the target neighborhood range in the determination in step S320 while stopping changing the injection molding condition set in the injection molding apparatus. As a result, the information processing device 20 can prevent the vibration of the measurement value of the first management item near the upper limit value or the lower limit value of the first allowable range, and can more reliably bring the measurement value closer to the target value. That is, the information processing device can improve the stability of the injection molding by the injection molding apparatus while preventing the deterioration of the quality of the product.

On the other hand, when the device control unit 243 determines that the target measurement value is not a value within the target neighborhood range (step S350-NO), the molding condition generation unit 244 generates an injection molding condition to be set in the injection molding apparatus under the restriction of changing the measurement value of the first management item within the maximum allowable change amount received in advance based on the target measurement value (step S360). That is, in step S360, the molding condition generation unit 244 generates the injection molding condition for changing the measurement value of the first management item within the maximum allowable change amount. In FIG. 13, the processing in step S360 is indicated by "GENERATE INJECTION MOLDING CONDITION UNDER RESTRICTION". The method of generating the injection molding condition based on the target measurement value may be a known method based on a response surface, a function, a regression model, a machine learning model, or the like indicating a correlation between the measurement value of the first management item and the injection molding condition, or may be a method to be developed.

The device control unit 243 starts condition setting processing of setting the injection molding condition generated by the molding condition generation unit 244 in step S360 in the injection molding apparatus (step S370). In FIG. 13, the processing in step S370 is indicated by "CHANGE INJECTION MOLDING CONDITION".

Then, the device control unit 243 waits until the change of the injection molding conditions set in the injection molding apparatus is completed (step S380). In FIG. 13, the processing in step S380 is indicated by "CHANGE OF INJECTION MOLDING CONDITION COMPLETED?". Here, in a case where the condition setting processing is started in step S370, that is, in a case where the injection molding condition generated in step S360 is set in the injection molding apparatus, when the state of the injection molding apparatus is a settable state determined in advance as a state in which the injection molding condition can be set, the device control unit 243 immediately sets the injection molding condition generated in step S360 in the injection molding apparatus. In contrast, in the case where the condition setting processing is started in step S370, when the state of the injection molding apparatus is not the settable state, the device control unit 243 waits until the state of the injection molding apparatus becomes the settable state. Thereafter, when the state of the injection molding apparatus becomes the settable state, the device control unit 243 sets the injection molding condition generated in step S360 in the injection molding apparatus. Here, the settable state is a state in which the injection molding apparatus does not execute a cycle among the states of the injection molding apparatus. More specifically, the settable state is a state in which the injection molding apparatus does not perform an operation for executing each cycle. In other words, the settable state is a state in which the injection molding apparatus does not use a power engine for performing injection molding, that is, an idling state of the injection molding apparatus. The settable state is realized, for example, in a period from when the injection molding apparatus ends execution of a certain cycle to when the injection molding apparatus starts to execute a cycle to be executed next to the cycle or the like during continuous execution of a plurality of cycles. Due to such circumstances, the information processing device 20 can prevent variations in product quality by changing the injection molding condition while the injection molding apparatus is executing the cycle. The device control unit 243 may be configured, when starting the condition setting processing in the injection molding condition change processing, to stop the power engine for the injection molding apparatus to perform injection molding, and set the injection molding condition generated in the injection molding condition change processing in the injection molding apparatus while stopping the power engine. Also in this case, the information processing device 20 can prevent variations in product quality by changing the injection molding condition while the injection molding apparatus is executing the cycle. As described above, when the condition setting processing of changing the injection molding condition set in the injection molding apparatus is started, the information processing device 20 stops all of the determination as to whether the target measurement value deviates from the first allowable range, the determination as to whether the target measurement value deviates from the second allowable range, and the determination as to whether the target measurement value deviates from the target neighborhood range until the change of the injection molding condition by the condition setting processing is completed.

When determining that the change of the injection molding condition set in the injection molding apparatus is completed (step S380-YES), the device control unit 243 waits until the output data is acquired from the injection molding apparatus after the change of the injection molding condition is completed, and when the output data is acquired from the injection molding apparatus after the change of the injection molding condition is completed, re-specifies the measurement value of the first management item indicated by the measurement value information contained in the acquired output data as the target measurement value. Then, the device control unit 243 transitions to step S350 and determines again whether the target measurement value is a value within the target neighborhood range.

In contrast, when it is determined that the target measurement value also deviates from the second allowable range (step S340-YES), the molding condition generation unit 244 removes the restriction of changing the measurement value of the first management item within the maximum allowable change amount (step S390).

Then, the molding condition generation unit 244 generates an injection molding condition to be set in the injection molding apparatus with the restriction of changing the measurement value of the first management item within the maximum allowable change amount removed based on the target measurement value (step S400). That is, in step S400, the molding condition generation unit 244 generates the injection molding condition for changing the measurement value of the first management item without restriction on the amount of change of the target measurement value. In FIG. 13, the processing in step S400 is indicated by "GENERATE INJECTION MOLDING CONDITION WITH RESTRICTION REMOVED". The method of generating the injection molding condition based on the target measurement value may be a known method based on a response surface, a function, a regression model, a machine learning model, or the like indicating a correlation between the measurement value of the first management item and the injection molding condition, or may be a method to be developed.

Next, the device control unit 243 starts a condition setting processing of setting the injection molding conditions generated by the molding condition generation unit 244 in step S400 in the injection molding apparatus (step S410). In FIG. 13, the processing in step S410 is indicated by "CHANGE INJECTION MOLDING CONDITION".

Then, the device control unit 243 waits until the change of the injection molding conditions set in the injection molding apparatus is completed (step S420). The processing in step S420 is the same as the processing in step S380. Therefore, in the present embodiment, the details of the processing in step S420 will be omitted.

When determining that the change of the injection molding condition set in the injection molding apparatus is completed (step S420-YES), the device control unit 243 waits until the cycle data is acquired from the injection molding apparatus after the change of the injection molding condition is completed, and when the cycle data is acquired from the injection molding apparatus after the change of the injection molding condition is completed, re-specifies the measurement value of the first management item indicated by the measurement value information contained in the acquired cycle data as the target measurement value. Then, the device control unit 243 transitions to step S340 and determines again whether the target measurement value deviates from the second allowable range.

As described above, the information processing device 20 determines whether the measurement value of the first management item deviates from at least the first allowable range of the first allowable range and the second allowable range based on the output data acquired from the injection molding apparatus, changes the injection molding condition set in the injection molding apparatus under the restriction of changing the measurement value of the first management item within the maximum allowable change amount when the measurement value of the first management item deviates from the first allowable range and falls between the first allowable range and the second allowable range, removes the restriction, and changes the injection molding condition set in the injection molding apparatus with the restriction removed when the measurement value of the first management item deviates from both the first allowable range and the second allowable range. Accordingly, the information processing device 20 can quickly bring the measurement value close to the target value when the measurement value of the management item significantly deviates from the target value, and can prevent the measurement value from significantly deviating from the target value when the measurement value slightly deviates from the target value. As a result, the information processing device 20 can prevent an increase in the time required to bring the measurement value of the management item close to the target value. The information processing device 20 determines whether the measurement value of the first management item deviates from the first allowable range based on the acquired output data at each time when acquiring the output data from the injection molding apparatus, changes the injection molding condition set in the injection molding apparatus when determining that the measurement value of the first management item deviates from the first allowable range in the determination, changes the injection molding condition set in the injection molding apparatus at each time when performing the determination until it is determined that the measurement value of the first management item falls in the target neighborhood range in the subsequent determination, and stops changing the injection molding condition set in the injection molding apparatus until it is determined again that the measurement value of the first management item deviates from the first allowable range in the determination when determining that the measurement value of the first management item falls in the target neighborhood range in the determination. Accordingly, the information processing device 20 can prevent the vibration of the measurement value of the management item near the upper limit value or the lower limit value of the first allowable range, and can more reliably bring the measurement value closer to the target value. As a result, the information processing device 20 can improve the stability of injection molding by the injection molding apparatus while preventing deterioration in the quality of the product.

Note that the information processing device 20 may be configured, in step S350 described above, even when the restriction of changing the measurement value of the first management item within the maximum allowable change amount is removed, not to impose the restriction again. That is, once the restriction is removed, the information processing device 20 keeps the restriction removed until one or more continuous executions of the cycle by the injection molding apparatus are finished. Accordingly, the information processing device 20 may more quickly bring the measurement value of the first management item closer to the target value.

In the example described above, the information processing device 20 may omit the processing in step S350 in the processing of the flowchart shown in FIG. 13. In this case, the information processing device 20 may be configured not to receive the upper limit value and the lower limit value of the target neighborhood range. Furthermore, in this case, when determining that the change of the injection molding condition set in the injection molding apparatus is completed in step S380, the information processing device 20 transitions to step S320. Even in this case, the information processing device 20 determines whether the measurement value of the first management item deviates from at least the first allowable range of the first allowable range and the second allowable range based on the output data acquired from the injection molding apparatus, changes the injection molding condition set in the injection molding apparatus under the restriction of changing the measurement value of the first management item within the maximum allowable change amount when the measurement value of the first management item deviates from the first allowable range and falls between the first allowable range and the second allowable range, removes the restriction and changes the injection molding condition set in the injection molding apparatus with the restriction removed when the measurement value of the first management item deviates from both the first allowable range and the second allowable range. Accordingly, the information processing device 20 can quickly bring the measurement value close to the target value when the measurement value of the management item significantly deviates from the target value, and can prevent the measurement value from significantly deviating from the target value when the measurement value slightly deviates from the target value. As a result, the information processing device 20 can prevent an increase in the time required to bring the measurement value of the management item close to the target value.

In the example described above, the information processing device 20 may omit the processing in step S340 and the processing in steps S390 to S420 in the processing of the flowchart shown in FIG. 13. In this case, the information processing device 20 may be configured not to receive the upper limit value and the lower limit value of the second allowable range. Furthermore, in this case, when determining that the target measurement value deviates from the first allowable range in step S320, the information processing device 20 transitions to step S350. Even in this case, the information processing device 20 determines whether the measurement value of the first management item deviates from the first allowable range based on the acquired output data at each time when acquiring the output data from the injection molding apparatus, changes the injection molding condition set in the injection molding apparatus when determining that the measurement value of the first management item deviates from the first allowable range in the determination, changes the injection molding condition set in the injection molding apparatus at each time when performing the determination until it is determined that the measurement value of the first management item falls in the target neighborhood range in the subsequent determination, and stops changing the injection molding condition set in the injection molding apparatus until it is determined again that the measurement value of the first management item deviates from the first allowable range in the determination when determining that the measurement value of the first management item falls in the target neighborhood range in the determination. Accordingly, the information processing device 20 can prevent the vibration of the measurement value of the management item near the upper limit value or the lower limit value of the first allowable range, and can more reliably bring the measurement value closer to the target value. As a result, the information processing device 20 can improve the stability of injection molding by the injection molding apparatus while preventing deterioration in the quality of the product.

### Modification 1 of Embodiment

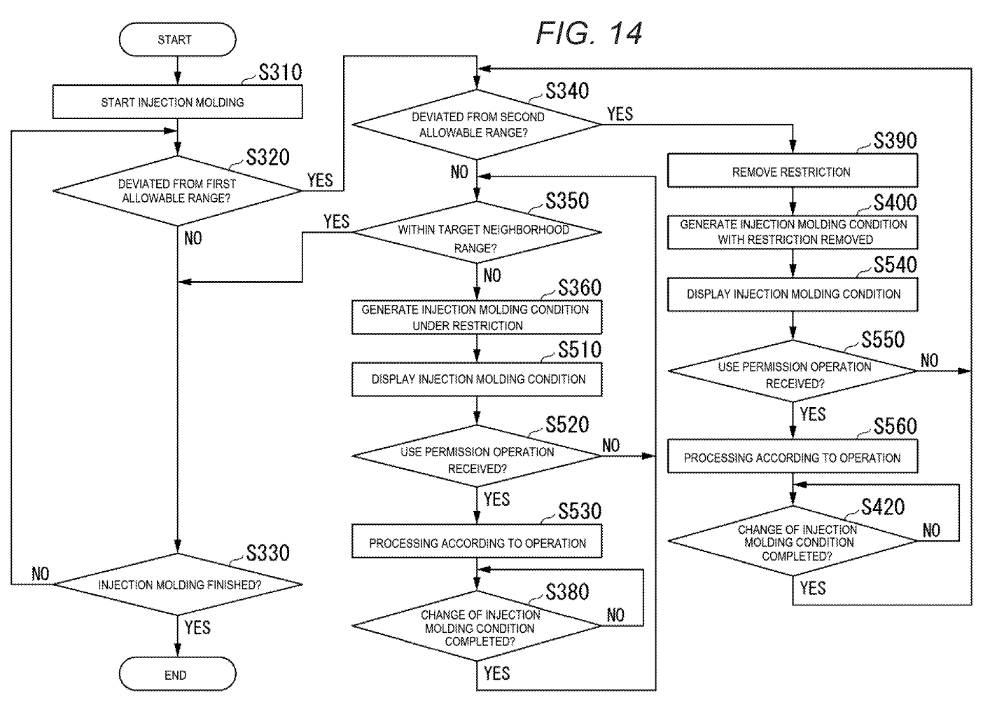

Modification 1 of the embodiment will now be described with reference to FIG. 14. In Modification 1 of the embodiment, the information processing device 20 confirms with the user whether to set the generated injection molding condition in the injection molding apparatus, and sets the generated injection molding condition in the injection molding apparatus when the approval by the user is received. FIG. 14 shows another example of the flow of the processing of causing the injection molding apparatus to perform injection molding by the information processing device 20. Hereinafter, as an example, a case where, in order to cause the injection molding apparatus to perform injection molding at a timing before the processing in step S310 shown in FIG. 14 is performed, a cycle execution operation for causing the injection molding apparatus to execute a cycle at a number of cycle executions received in advance as the number of times of execution of the cycle is received will be described. Furthermore, hereinafter, as an example, a case where the processing of the flowcharts shown in FIGS. 11 and 12 have been executed at the timing will be described. The processing in steps S310 to S360, steps S380 to S400, and step S420 shown in FIG. 14 are the same as the processing in steps S310 to S360, steps S380 to S400, and step S420 shown in FIG. 13, respectively. Therefore, the description of each of the processing in steps S310 to S360, steps S380 to S400, and step S420 shown in FIG. 14 will be omitted.

After generating the injection molding condition to be set in the injection molding apparatus in step S360, the display control unit 245 generates a use permission image including information indicating the injection molding condition generated in step S360 and an operation reception image for receiving an operation indicating whether to use the injection molding condition as an injection molding condition to be newly set in the injection molding apparatus, and displays the generated use permission image (step S510). Here, the use permission image may be any image as long as the image includes the information and the operation reception image. In FIG. 14, the processing in step S510 is indicated by "DISPLAY INJECTION MOLDING CONDITION".

Then, the device control unit 243 waits until an operation on the operation reception image of the use permission image displayed in step S510 is received (step S520). In FIG. 14, the processing in step S520 is indicated by "USE PERMISSION OPERATION RECEIVED?".

When it is determined that the operation on the operation reception image of the use permission image displayed in step S510 is received (step S520-YES), the device control unit 243 performs processing according to the operation received via the operation reception image (step S530), and transitions to step S380. For example, in step S530, when receiving an operation indicating that the injection molding condition generated in step S360 is not used as an injection molding condition to be newly set in the injection molding apparatus via the operation reception image, the device control unit 243 discards the injection molding condition generated in step S360 and transitions to step S350. In this case, the injection molding apparatus continues the execution of the cycle under the injection molding condition originally set, and in the flowchart shown in FIG. 14, omits step S380 and transitions to step S350. On the other hand, for example, in step S530, when receiving an operation indicating that the injection molding condition generated in step S360 is used as an injection molding condition to be newly set in the injection molding apparatus via the operation reception image, the device control unit 243 starts condition setting processing of setting the injection molding condition generated in step S360 in the injection molding apparatus, and transitions to step S380. In FIG. 14, the processing in step S530 is indicated by "PROCESS ACCORDING TO OPERATION".

After generating the injection molding condition to be set in the injection molding apparatus in step S400, the display control unit 245 generates a use permission image including information indicating the injection molding condition generated in step S400 and an operation reception image for receiving an operation indicating whether to use the injection molding condition as an injection molding condition to be newly set in the injection molding apparatus, and displays the generated use permission image (step S540). In FIG. 14, the processing in step S540 is indicated by "DISPLAY INJECTION MOLDING CONDITION".

Then, the device control unit 243 waits until an operation on the operation reception image of the use permission image displayed in step S540 is received (step S550). In FIG. 14, the processing in step S550 is indicated by "USE PERMISSION OPERATION RECEIVED?".

When it is determined that the operation on the operation reception image of the use permission image displayed in step S550 is received (step S550-YES), the device control unit 243 performs processing according to the operation received via the operation reception image (step S560), and transitions to step S420. For example, in step S560, when receiving an operation indicating that the injection molding condition generated in step S400 is not used as an injection molding condition to be newly set in the injection molding apparatus via the operation reception image, the device control unit 243 discards the injection molding condition generated in step S400 and transitions to step S340. In this case, the injection molding apparatus continues the execution of the cycle under the injection molding condition originally set, and in the flowchart shown in FIG. 14, omits step S420 and transitions to step S340. On the other hand, for example, in step S560, when receiving an operation indicating that the injection molding condition generated in step S400 is used as an injection molding condition to be newly set in the injection molding apparatus via the operation reception image, the device control unit 243 starts condition setting processing of setting the injection molding condition generated in step S400 in the injection molding apparatus, and transitions to step S420.

As described above, in Modification 1 of the embodiment, the information processing device 20 confirms with the user whether to set the generated injection molding condition in the injection molding apparatus, and sets the generated injection molding condition in the injection molding apparatus when the approval by the user is received. Thus, the information processing device 20 can obtain the same effects as those obtained by the information processing device 20 according to the embodiment.

### Modification 2 of Embodiment

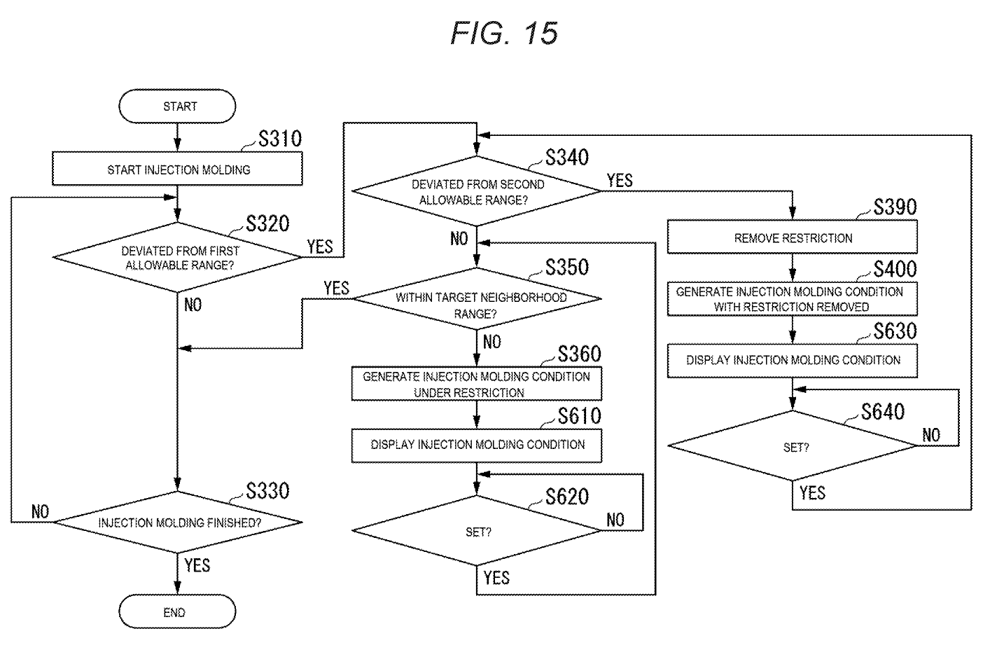

Modification 2 of the embodiment will now be described with reference to FIG. 15. In Modification 2 of the embodiment, the information processing device 20 causes the user to determine whether to set the generated injection molding condition in the injection molding apparatus, and causes the user to perform the work of setting the generated injection molding condition in the injection molding apparatus. FIG. 15 shows still another example of the flow of the processing of causing the injection molding apparatus to perform injection molding by the information processing device 20. Hereinafter, as an example, a case where, in order to cause the injection molding apparatus to perform injection molding at a timing before the processing of step S310 shown in FIG. 15 is performed, a cycle execution operation for causing the injection molding apparatus to execute a cycle at a number of cycle executions received in advance as the number of times of execution of the cycle is received will be described. Furthermore, hereinafter, as an example, a case where the processing of the flowcharts shown in FIGS. 11 and 12 have been executed at the timing will be described. The processing in steps S310 to S360, step S390, and step S400 shown in FIG. 15 are the same as the processing in steps S310 to S360, step S390, and step S400 shown in FIG. 13, respectively. Therefore, the description of each of the processing of steps S310 to S360, step S390, and step S400 shown in FIG. 15 will be omitted.

After generating the injection molding condition to be set in the injection molding apparatus in step S360, the display control unit 245 generates a condition display image including information indicating the injection molding condition generated in step S360, and displays the generated condition display image (step S610). Here, the condition display image may be any image as long as the image includes the information. In FIG. 15, the processing in step S610 is indicated by "DISPLAY INJECTION MOLDING CONDITION".

Then, the device control unit 243 waits until the injection molding condition generated in step S360 is set in the injection molding apparatus by the user (step S620). The method of specifying whether the injection molding condition is set in the injection molding apparatus by the device control unit 243 may be a known method or a method to be developed. The method of setting the injection molding conditions in the injection molding apparatus by the user may be a known method or a method to be developed. In FIG. 15, the processing in step S620 is indicated by "SET?".

When determining that the injection molding condition generated in step S360 is set in the injection molding apparatus by the user (step S620-YES), the device control unit 243 transitions to step S350. The waiting in step S620 continues until the user sets the injection molding condition in the injection molding apparatus, and may continue for a period of time in which cycles are executed several times by the injection molding apparatus. In this case, the device control unit 243 specifies, as the target measurement value, the measurement value of the first management item indicated by the measurement value information contained in the output data first acquired from the injection molding apparatus after the setting of the injection molding condition in the injection molding apparatus is completed, and then transitions to step S350.

After generating the injection molding condition to be set in the injection molding apparatus in step S400, the display control unit 245 generates a condition display image including information indicating the injection molding condition generated in step S400, and displays the generated condition display image (step S630). In FIG. 15, the processing in step S630 is indicated by "DISPLAY INJECTION MOLDING CONDITION".

Then, the device control unit 243 waits until the injection molding condition generated in step S400 is set in the injection molding apparatus by the user (step S640). The processing in step S640 is the same as the processing in step S620. Therefore, in the present embodiment, the description of the processing in step S640 will be omitted. In FIG. 15, the processing in step S640 is indicated by "SET?".

When determining that the injection molding condition generated in step S400 is set in the injection molding apparatus by the user (step S640-YES), the device control unit 243 transitions to step S340. The waiting in step S640 continues until the user sets the injection molding condition in the injection molding apparatus, and may continue for a period of time in which cycles are executed several times by the injection molding apparatus. In this case, the device control unit 243 specifies, as the target measurement value, the measurement value of the first management item indicated by the measurement value information contained in the output data first acquired from the injection molding apparatus after the setting of the injection molding condition in the injection molding apparatus is completed, and then transitions to step S340.

As described above, in Modification 2 of the embodiment, the information processing device 20 causes the user to determine whether to set the generated injection molding condition in the injection molding apparatus, and causes the user to perform the work of setting the generated injection molding condition in the injection molding apparatus. Thus, the information processing device 20 can obtain the same effects as those obtained by the information processing device 20 according to the embodiment.

The molding management system 1 described above may include the terminal device 40. The molding management system 1 described above may include an injection molding apparatus such as the injection molding apparatus 11. The server 30 may have the functions, the configurations, and the like of the information processing device 20 described above.

The detailed configurations described above may be combined in any manner.

### Appendix 1

A molding management system includes an information processing device communicably coupled to a terminal device for management of production of a product in a production process including an injection molding step of the product by an injection molding apparatus, wherein the information processing device acquires output data output from the injection molding apparatus for each cycle of injection molding performed by the injection molding apparatus, the output data is data in which cycle data including measurement value information indicating each of one or more measurement values measured in the injection molding apparatus in response to execution of the cycle by the injection molding apparatus is associated with injection molding condition data including injection molding condition information indicating an injection molding condition set in the injection molding apparatus, the one or more measurement values include a measurement value for each of one or more management items correlated with quality of the product, and the information processing device receives a target value of a first management item among the one or more management items, a first allowable range allowed as a deviation of the measurement value of the first management item from the target value, and a second allowable range allowed as a deviation of the measurement value of the first management item from the first allowable range according to a received operation, determines whether the measurement value of the first management item deviates from at least the first allowable range of the first allowable range and the second allowable range based on the output data acquired from the injection molding apparatus, when the measurement value of the first management item deviates from the first allowable range and falls between the first allowable range and the second allowable range, changes an injection molding condition set in the injection molding apparatus under a restriction of changing the measurement value of the first management item within a maximum allowable change amount that is allowable as an amount of change of the measurement value of the first management item, and, when the measurement value of the first management item deviates from both the first allowable range and the second allowable range, removes the restriction and changes the injection molding condition set in the injection molding apparatus with the restriction removed.

In the molding management system according to [1], the information processing device performs the determination at each time when acquiring the output data from the injection molding apparatus.

In the molding management system according to [1] or [2], when starting processing of changing the injection molding condition set in the injection molding apparatus, the information processing device stops the determination until a change in the injection molding condition by the processing is completed.

In the molding management system according to any one of [1] to [3], the maximum allowable change amount is an amount smaller than a maximum value of the amount of change of the measurement value of the first management item when the injection molding condition changes with the restriction removed.

In the molding management system according to [4], an absolute value of the maximum allowable change amount is an amount equal to or smaller than an absolute value of a difference between an upper limit value of the first allowable range and an upper limit value of the second allowable range, or an amount equal to or smaller than an absolute value of a difference between a lower limit value of the first allowable range and a lower limit value of the second allowable range.

In the molding management system according to [4], the maximum allowable change amount is an amount obtained by multiplying an absolute value of a difference between an upper limit value of the first allowable range and the target value of the first management item by a predetermined ratio.

In the molding management system according to [6], the information processing device receives a ratio received by a predetermined operation as the predetermined ratio.

In the molding management system according to any one of [1] to [7], the information processing device does not change the injection molding condition set in the injection molding apparatus when the measurement value of the first management item falls within the first allowable range in the determination.

In the molding management system according to any one of [1] to [8], the information processing device generates an injection molding condition for changing the measurement value of the first management item within the maximum allowable change amount as the injection molding condition to be set in the injection molding apparatus based on the latest output data acquired from the injection molding apparatus when changing the injection molding condition set in the injection molding apparatus under the restriction, and generates an injection molding condition to be set in the injection molding apparatus for changing the measurement value of the first management item without a restriction on the amount of change of the measurement value of the first management item based on the latest output data acquired from the injection molding apparatus when changing the injection molding condition set in the injection molding apparatus with the restriction removed.

In the molding management system according to any one of [1] to [3], once removing the restriction, the information processing device keeps the restriction removed until one or more continuous executions of the cycle by the injection molding apparatus are finished.

In the molding management system according to any one of [1] to , the information processing device imposes the restriction again when the measurement value of the first management item deviates from the first allowable range and falls between the first allowable range and the second allowable range in the determination after once removing the restriction.

In the molding management system according to any one of [1] to , the information processing device receives a target neighborhood range indicating a neighborhood of the target value of the measurement value of the first management item in addition to the target value of the first management item, the first allowable range, and the second allowable range according to the received operation, and the target neighborhood range is a range contained in the first allowable range.

The molding management system according to any one of [1] to , further includes the terminal device.

The molding management system according to any one of [1] to , further includes the injection molding apparatus.

### Appendix 2

A molding management system includes an information processing device communicably coupled to a terminal device for management of production of a product in a production process including an injection molding step of the product by an injection molding apparatus, wherein the information processing device acquires output data output from the injection molding apparatus for each cycle of injection molding performed by the injection molding apparatus, the output data is data in which cycle data including measurement value information indicating each of one or more measurement values measured in the injection molding apparatus in response to execution of the cycle by the injection molding apparatus is associated with injection molding condition data including injection molding condition information indicating an injection molding condition set in the injection molding apparatus, the one or more measurement values include a measurement value for each of one or more management items correlated with quality of the product, and the information processing device receives a target value of a first management item among the one or more management items, a first allowable range allowed as a deviation of the measurement value of the first management item from the target value, and a target neighborhood range indicating a neighborhood of the target value of the measurement value of the first management item according to a received operation.

In the molding management system according to [1], the information processing device determines whether the measurement value of the first management item deviates from the first allowable range based on the acquired output data at each time when acquiring the output data from the injection molding apparatus, when determining that the measurement value of the first management item deviates from the first allowable range in the determination, changes the injection molding condition set in the injection molding apparatus based on the acquired output data, changes the injection molding condition set in the injection molding apparatus based on the acquired output data at each time when performing the determination until it is determined that the measurement value of the first management item falls in the target neighborhood range in the subsequent determination, and stops changing the injection molding condition set in the injection molding apparatus until it is determined again that the measurement value of the first management item deviates from the first allowable range in the determination when determining that the measurement value of the first management item falls in the target neighborhood range in the determination.

In the molding management system according to [2], the information processing device does not change the injection molding condition set in the injection molding apparatus even when it is determined that the measurement value of the first management item falls between the first allowable range and the target neighborhood range in the determination while stopping changing the injection molding condition set in the injection molding apparatus.

In the molding management system according to any one of [1] to [3], the target neighborhood range is contained in the first allowable range.

In the molding management system according to any one of [1] to [4], the information processing device receives a second allowable range allowed as a deviation of the measurement value of the first management item from the first allowable range in addition to the target value of the first management item, the first allowable range, and the target neighborhood range according to a received operation, and the first allowable range is contained in the second allowable range.

The molding management system according to any one of [1] to [5], further includes the terminal device.

The molding management system according to any one of [1] to [6], further includes the injection molding apparatus.

The embodiments of the present disclosure are described in detail above with reference to the drawings. However, specific configurations are not limited to the embodiments and may be, for example, changed, replaced, or deleted without departing from the gist of the present disclosure.

A program for implementing the function of any component in the device described above may be recorded in a computer-readable storage medium and the program may be loaded and executed in a computer system. Here, the device is, for example, the injection molding apparatus 11, the information processing device 20, the server 30, or the terminal device 40. The "computer system" referred to here includes an operating system (OS) and hardware such as peripheral devices. The "computer-readable storage medium" refers to a portable medium such as a flexible disc, a magneto-optical disc, a ROM, or a compact disk (CD) ROM or a storage device such as a hard disk built in the computer system. Furthermore, the "computer-readable storage medium" includes a medium that stores the program for a certain period of time, such as a volatile memory inside the computer system serving as a server or a client when the program is transmitted via a network such as the Internet or a communication line such as a telephone line.

The program may be transmitted from a computer system in which the program is stored in a storage device or the like to another computer system via a transmission medium or a transmission wave in the transmission medium. Here, the "transmission medium" for transmitting the program refers to a medium having a function of transmitting information like a network such as the Internet or a communication line such as a telephone line.

The program may be a program for implementing part of the functions described above. Furthermore, the program may be a so-called differential file or differential program that can implement the functions described above in combination with a program already recorded in the computer system.

What is claimed is:

1. A molding management system comprising an information processing device communicably coupled to a terminal device for management of production of a product in a production process including an injection molding step of the product by an injection molding apparatus, wherein
the information processing device acquires output data output from the injection molding apparatus for each cycle of injection molding performed by the injection molding apparatus,
the output data is data in which cycle data including measurement value information indicating each of one or more measurement values measured in the injection molding apparatus in response to execution of the cycle by the injection molding apparatus is associated with injection molding condition data including injection molding condition information indicating an injection molding condition set in the injection molding apparatus,
the one or more measurement values include a measurement value for each of one or more management items correlated with quality of the product, and
the information processing device receives a target value of a first management item among the one or more management items, a first allowable range allowed as a deviation of the measurement value of the first management item from the target value, and a second allowable range allowed as a deviation of the measurement value of the first management item from the first allowable range according to a received operation, determines whether the measurement value of the first management item deviates from at least the first allowable range of the first allowable range and the second allowable range based on the output data acquired from the injection molding apparatus, when the measurement value of the first management item deviates from the first allowable range and falls between the first allowable range and the second allowable range, changes an injection molding condition set in the injection molding apparatus under a restriction of changing the measurement value of the first management item within a maximum allowable change amount that is allowable as an amount of change of the measurement value of the first management item, and, when the measurement value of the first management item deviates from both the first allowable range and the second allowable range, removes the restriction and changes the injection molding condition set in the injection molding apparatus with the restriction removed.

2. The molding management system according to claim 1, wherein
the information processing device performs the determination at each time when acquiring the output data from the injection molding apparatus.

3. The molding management system according to claim 1, wherein
when starting processing of changing the injection molding condition set in the injection molding apparatus, the information processing device stops the determination until a change in the injection molding condition by the processing is completed.

4. The molding management system according to claim 1, wherein
the maximum allowable change amount is an amount smaller than a maximum value of the amount of change of the measurement value of the first management item when the injection molding condition changes with the restriction removed.

5. The molding management system according to claim 1, wherein
an absolute value of the maximum allowable change amount is an amount equal to or smaller than an absolute value of a difference between an upper limit value of the first allowable range and an upper limit value of the second allowable range, or an amount equal to or smaller than an absolute value of a difference between a lower limit value of the first allowable range and a lower limit value of the second allowable range.

6. The molding management system according to claim 1, wherein
the maximum allowable change amount is an amount obtained by multiplying an absolute value of a difference between an upper limit value of the first allowable range and the target value of the first management item by a predetermined ratio.

7. The molding management system according to claim 6, wherein
the information processing device receives a ratio received by a predetermined operation as the predetermined ratio.

8. The molding management system according to claim 1, wherein
the information processing device does not change the injection molding condition set in the injection molding apparatus when the measurement value of the first management item falls within the first allowable range in the determination.

9. The molding management system according to claim 1, wherein
the information processing device generates the injection molding condition for changing the measurement value of the first management item within the maximum allowable change amount as the injection molding condition to be set in the injection molding apparatus based on the latest output data acquired from the injection molding apparatus when changing the injection molding condition set in the injection molding apparatus under the restriction, and generates an injection molding condition to be set in the injection molding apparatus for changing the measurement value of the first management item without a restriction on the amount of change of the measurement value of the first management item based on the latest output data acquired from the injection molding apparatus when changing the injection molding condition set in the injection molding apparatus with the restriction removed.

10. The molding management system according to claim 1, wherein,
once removing the restriction, the information processing device keeps the restriction removed until one or more continuous executions of the cycle by the injection molding apparatus are finished.

11. The molding management system according to claim 1, wherein
the information processing device imposes the restriction again when the measurement value of the first management item deviates from the first allowable range and falls between the first allowable range and the second allowable range in the determination after once removing the restriction.

12. The molding management system according to claim 1, wherein
the information processing device receives a target neighborhood range indicating a neighborhood of the target value of the measurement value of the first management item in addition to the target value of the first management item, the first allowable range, and the second allowable range according to the received operation, and
the target neighborhood range is a range contained in the first allowable range.

13. The molding management system according to claim 1, further comprising the terminal device.

14. The molding management system according to claim 1, further comprising the injection molding apparatus.
